(19) United States
(12) Patent Application Publication
(10) Pub. No.: US 2024/0054379 A1
(43) Pub. Date: Feb. 15, 2024

(54) Parallel Data Processing using Hybrid Computing System for Machine Learning Applications

(71) Applicants: Rigetti & Co., LLC, Berkeley, CA (US); Rigetti Australia Pty Ltd., Adelaide (AU)

(72) Inventors: Mark James Hodson, Highgate (AU); Maxwell Phillip Henderson, Philadelphia, PA (US)

(73) Assignees: Rigetti & Co., LLC, Berkeley, CA (US); Rigetti Australia Pty Ltd., Adelaide (AU)

(21) Appl. No.: 18/496,047

(22) Filed: Oct. 27, 2023

Related U.S. Application Data
(63) Continuation of application No. PCT/US2022/027074, filed on Apr. 29, 2022.
(60) Provisional application No. 63/182,353, filed on Apr. 30, 2021.

(51) Int. Cl. G06N 10/20; G06N 20/00

(52) U.S. Cl. CPC G06N 10/20; G06N 20/00

(57) ABSTRACT

In a general aspect, a machine learning process is performed using data-parallel quantum processing. In some cases, a machine learning model is operated in a hybrid computing system. The hybrid computing system includes a quantum computing resource and a classical computing resource. The quantum computing resource includes quantum processing unit (QPU) sublattices, each including a subset of qubit devices. Methods for operating a machine learning model include defining quantum logic circuits to be executed on the respective QPU sublattices, wherein each quantum logic circuit is configured according to parameters of the machine learning model; translating the quantum logic circuits into quantum control programs for the respective QPU sublattices; determining control parameters for the respective quantum control programs; executing the quantum control programs on the respective QPU sublattices to obtain readout samples from the respective QPU sublattices; and calculating activation parameters of the machine learning model based on the readout samples.

### CROSS-REFERENCE TO RELATED APPLICATIONS

This application claims priority to U.S. Provisional Application No. 63/182,353 filed on Apr. 30, 2021, and entitled “Parallel Data Processing using Quantum Processing Units for Machine Learning Applications.” The above-referenced priority application is hereby incorporated by reference.

### BACKGROUND

The following description relates to performing parallel data processing by operating a hybrid computing system for machine learning applications.

Quantum computers can perform computational tasks by storing and processing information within quantum states of quantum systems. For example, qubits (i.e., quantum bits) can be stored in, and represented by, an effective two-level sub-manifold of a quantum coherent physical system. A variety of physical systems have been proposed for quantum computing applications. Examples include superconducting quantum circuits, trapped ions, spin systems, and others.

### BRIEF DESCRIPTION OF THE DRAWINGS

FIG. 1 is a block diagram of an example computing system.

FIG. 2A is a schematic diagram showing aspects of an example quantum processing unit.

FIG. 2B is a schematic diagram showing an example segmentation of the example quantum processing unit (QPU) in FIG. 2A to form QPU sublattices for parallel data processing in a machine learning algorithm.

FIG. 3 is a schematic diagram showing aspects of an example quantum logic circuit.

FIG. 4 is a flow chart showing an example machine learning process that includes quantum processing.

FIG. 5 is a schematic diagram showing aspects of an example hybrid processing pipeline for machine learning.

### DETAILED DESCRIPTION

In some aspects of what is described here, one or more quantum processing units (QPUs) are used for parallel data processing in processing pipelines for machine learning applications. The parallel data processing resources may include some or all of the classical software and quantum hardware control processing that are used to operate a hybrid computing system. In some instances, a single quantum processing unit is utilized to perform data-parallel operations compatible with the input and output requirements of data-parallel machine learning applications, or multiple quantum processing units may be utilized. One or more quantum processing units can be segmented into multiple QPU sublattices, which can be simultaneously controlled for implementing a machine learning algorithm.

Machine learning systems, commercially viable across industry sectors, can be used to classify objects in complex scenes, increase the resolution of noisy images, and generate synthetic samples from complex data distributions. Convolutional neural networks (CNN), deep belief networks (DBN), and generative adversarial networks (GAN) are examples of classical machine learning algorithms that can be applied to these types of applications. In some instances, quantum computers are capable of performing calculations that are not tractable on a classical computer. This quantum computational power can be integrated with machine learning systems and can result in new quantum machine learning algorithms providing alternative approaches to classical machine learning algorithms. Quantum computing resources can be integrated with classical computing resources in a scalable, data-parallel pipeline, which can be used in machine learning applications or other types of applications. Leveraging this power could improve the speed, accuracy, or energy-efficiency of machine learning processes and deliver an advantage to these types of applications.

In some implementations, the systems and techniques described here can provide technical advantages and improvements. For example, the systems and methods disclosed here may enhance classical machine learning methods with quantum computing resources by minimizing the total processing time and enable effective Quantum Machine Learning (QML) solutions to a variety of problems. The systems and methods disclosed here may also allow integration of quantum circuit Born machines and other unique quantum algorithms as a replacement for classical machine learning algorithms.

The systems and methods disclosed here can provide multiple levers to tailor the level of quantum computational power sought by an application, from a single device up to multiple devices. In some examples, the systems and methods disclosed here can enable lattice sub-letting and further reduce cost by shared tenancy (in space rather than in time), and allow the user to access additional capability, providing a net benefit in non-linear or threshold commercial business decisions (e.g., that a computation is complete within a certain time for it to have any value). In some examples, the systems and methods disclosed here increase the quantum computational power, maximize the duty cycle of the quantum computational power, and thus benefit per unit cost of quantum computing resources. In some cases, a combination of these and potentially other advantages and improvements may be obtained.

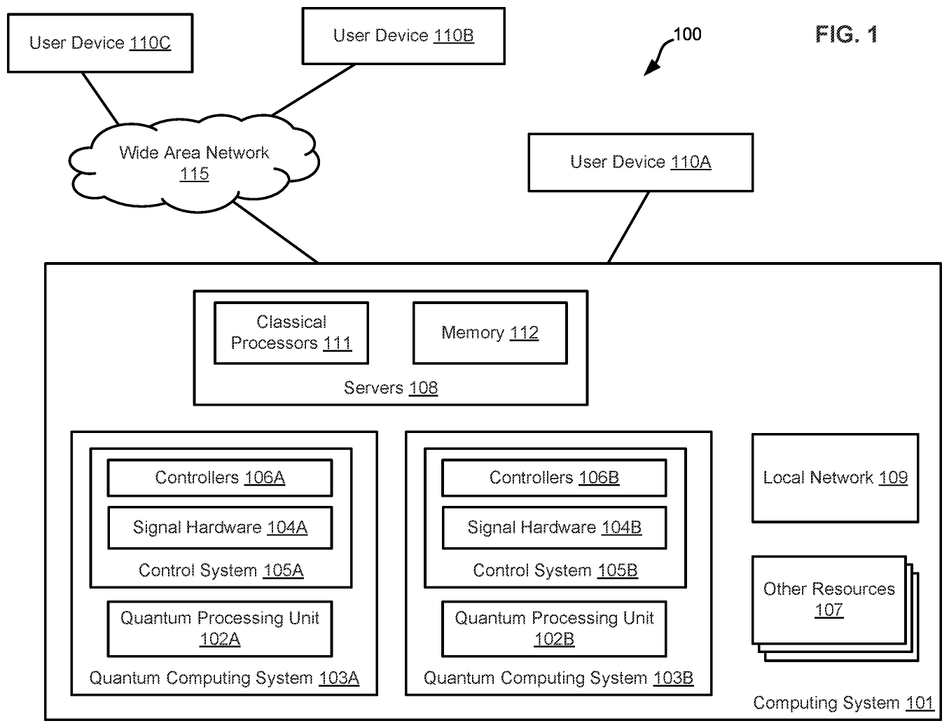

FIG. 1 is a block diagram of an example computing environment 100. The example computing environment 100 shown in FIG. 1 includes a computing system 101 and user devices 110A, 110B, 110C. A computing environment may include additional or different features, and the components of a computing environment may operate as described with respect to FIG. 1 or in another manner.

The example computing system 101 includes classical and quantum computing resources and exposes their functionality to the user devices 110A, 110B, 110C (referred to collectively as “user devices 110”). The computing system 101 shown in FIG. 1 includes one or more servers 108, quantum computing systems 103A, 103B, a local network 109, and other resources 107. The computing system 101 may also include one or more user devices (e.g., the user device 110A) as well as other features and components. A computing system may include additional or different features, and the components of a computing system may operate as described with respect to FIG. 1 or in another manner.

The example computing system 101 can provide services to the user devices 110, for example, as a cloud-based or remote-accessed computer system, as a distributed computing resource, as a supercomputer or another type of high-performance computing resource, or in another manner. The computing system 101 or the user devices 110 may also have access to one or more other quantum computing systems (e.g., quantum computing resources that are accessible through the wide area network 115, the local network 109, or otherwise).

The user devices 110 shown in FIG. 1 may include one or more classical processors, memory, user interfaces, communication interfaces, and other components. For instance, the user devices 110 may be implemented as laptop computers, desktop computers, smartphones, tablets, or other types of computer devices. In the example shown in FIG. 1, to access computing resources of the computing system 101, the user devices 110 send information (e.g., programs, instructions, commands, requests, input data, etc.) to the servers 108; and in response, the user devices 110 receive information (e.g., application data, output data, prompts, alerts, notifications, results, etc.) from the servers 108. The user devices 110 may access services of the computing system 101 in another manner, and the computing system 101 may expose computing resources in another manner.

In the example shown in FIG. 1, the local user device 110A operates in a local environment with the servers 108 and other elements of the computing system 101. For instance, the user device 110A may be co-located with (e.g., located within 0.5 to 1 km of) the servers 108 and possibly other elements of the computing system 101. As shown in FIG. 1, the user device 110A communicates with the servers 108 through a local data connection.

The local data connection in FIG. 1 is provided by the local network 109. For example, some or all of the servers 108, the user device 110A, the quantum computing systems 103A, 103B and the other resources 107 may communicate with each other through the local network 109. In some implementations, the local network 109 operates as a communication channel that provides one or more low-latency communication pathways from the server 108 to the quantum computer systems 103A, 103B (or to one or more of the elements of the quantum computer systems 103A, 103B). The local network 109 can be implemented, for instance, as a wired or wireless Local Area Network, an Ethernet connection, or another type of wired or wireless connection. The local network 109 may include one or more wired or wireless routers, wireless access points (WAPs), wireless mesh nodes, switches, high-speed cables, or a combination of these and other types of local network hardware elements. In some cases, the local network 109 includes a software-defined network that provides communication among virtual resources, for example, among an array of virtual machines operating on the server 108 and possibly elsewhere.

In the example shown in FIG. 1, the remote user devices 110B, 110C operate remote from the servers 108 and other elements of the computing system 101. For instance, the user devices 110B, 110C may be located at a remote distance (e.g., more than 1 km, 10 km, 100 km, 1,000 km, 10,000 km, or farther) from the servers 108 and possibly other elements of the computing system 101. As shown in FIG. 1, each of the user devices 110B, 110C communicates with the servers 108 through a remote data connection.

The remote data connection in FIG. 1 is provided by a wide area network 115, which may include, for example, the Internet or another type of wide area communication network. In some cases, remote user devices use another type of remote data connection (e.g., satellite-based connections, a cellular network, a virtual private network, etc.) to access the servers 108. The wide area network 115 may include one or more internet servers, firewalls, service hubs, base stations, or a combination of these and other types of remote networking elements. Generally, the computing environment 100 can be accessible to any number of remote user devices.

The example servers 108 shown in FIG. 1 can manage interaction with the user devices 110 and utilization of the quantum and classical computing resources in the computing system 101. For example, based on information from the user devices 110, the servers 108 may delegate computational tasks to the quantum computing systems 103A, 103B and the other resources 107; the servers 108 can then send information to the user devices 110 based on output data from the computational tasks performed by the quantum computing systems 103A, 103B and the other resources 107.

As shown in FIG. 1, the servers 108 are classical computing resources that include classical processors 111 and memory 112. The servers 108 may also include one or more communication interfaces that allow the servers to communicate via the local network 109, the wide area network 115, and possibly other channels. In some implementations, the servers 108 may include a host server, an application server, a virtual server, or a combination of these and other types of servers. The servers 108 may include additional or different features, and may operate as described with respect to FIG. 1 or in another manner.

The classical processors 111 can include various kinds of apparatus, devices, and machines for processing data, including, by way of example, a microprocessor, a central processing unit (CPU), a graphics processing unit (GPU), an FPGA (field programmable gate array), an ASIC (application specific integrated circuit), or combinations of these. The memory 112 can include, for example, a random-access memory (RAM), a storage device (e.g., a writable read-only memory (ROM) or others), a hard disk, or another type of storage medium. The memory 112 can include various forms of volatile or non-volatile memory, media, and memory devices, etc.

Each of the example quantum computing systems 103A, 103B operates as a quantum computing resource in the computing system 101. The other resources 107 may include additional quantum computing resources (e.g., quantum computing systems, quantum simulators, or both) as well as classical (non-quantum) computing resources such as, for example, digital microprocessors, specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), etc., or combinations of these and other types of computing modules.

In some implementations, the servers 108 generate programs, identify appropriate computing resources (e.g., a QPU or quantum virtual machine (QVM)) in the computing system 101 to execute the programs, and send the programs to the identified resources for execution. For example, the servers 108 may send programs to the quantum computing system 103A, the quantum computing system 103B, or any of the other resources 107. The programs may include classical programs, quantum programs, hybrid classical/quantum programs, and may include any type of function, code, data, instruction set, etc.

In some instances, programs can be formatted as source code that can be rendered in human-readable form (e.g., as text) and can be compiled, for example, by a compiler running on the servers 108, on the quantum computing systems 103, or elsewhere. In some instances, programs can be formatted as compiled code, such as, for example, binary code (e.g., machine-level instructions) that can be executed directly by a computing resource. Each program may include instructions corresponding to computational tasks that, when performed by an appropriate computing resource, generate output data based on input data. For example, a program can include instructions formatted for a quantum computer system, a simulator, a digital microprocessor, co-processor or other classical data processing apparatus, or another type of computing resource.

In some cases, a program may be expressed in a hardware-independent format. For example, quantum machine instructions may be provided in a quantum instruction language such as Quil, described in the publication “A Practical Quantum Instruction Set Architecture,” arXiv:1608.03355v2, dated Feb. 17, 2017, or another quantum instruction language. For instance, the quantum machine instructions may be written in a format that can be executed by a broad range of quantum processing units or simulators. In some cases, a program may be expressed in high-level terms of quantum logic gates or quantum algorithms, in lower-level terms of fundamental qubit rotations and controlled rotations, or in another form. In some cases, a program may be expressed in terms of control signals (e.g., pulse sequences, delays, etc.) and parameters for the control signals (e.g., frequencies, phases, durations, channels, etc.). In some cases, a program may utilize Quil-T, described in the publication “Gain deeper control of Rigetti quantum processors with Quil-T,” available at https://medium.com/rigetti/gain-deeper-control-of-rigetti-quantum-processors-with-quil-t-ea8943061e5b, dated Dec. 10, 2020. In some cases, a program may be expressed in another form or format.

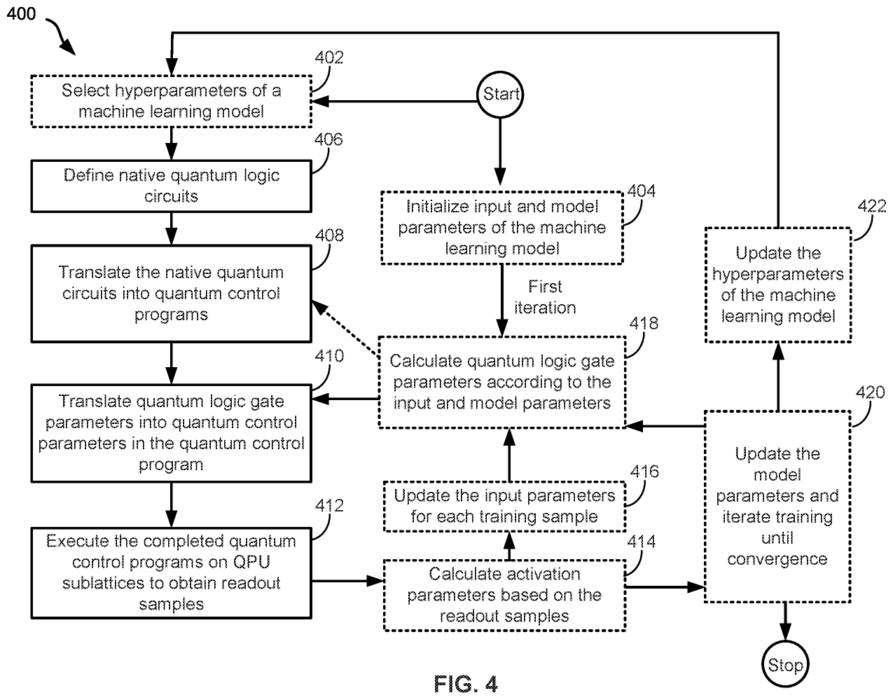

In some implementations, the servers 108 include one or more compilers that convert programs between formats. For example, the servers 108 may include a compiler that converts hardware-independent instructions (e.g., in a user program received from a user device 110 directly or through the wide area network 115) to hardware specific instructions (e.g., native quantum logic circuits specifically for the quantum processing unit 102 where the quantum operations are performed) and further to binary programs (e.g., quantum control programs) for execution by the quantum computing systems 103A, 103B. In some cases, a compiler can compile a program to a format that targets a specific quantum resource in the computer system 101. For example, a compiler may generate a different binary program (e.g., from the same source code) depending on whether the program is to be executed by the quantum computing system 103A or the quantum computing system 103B according to device parameters of the quantum circuit devices in the quantum processing units 102A, 102B. In some implementations, one or more compilers in the classical processor 111 of the server 108 are configured to perform part of the operations in the example process 400 in FIG. 4.

In some cases, a compiler generates a partial binary program that can be updated, for example, based on specific parameters. For instance, if a quantum program is to be executed iteratively on a quantum computing system with varying parameters on each iteration, the compiler may generate the binary program in a format that can be updated with specific parameter values at runtime (e.g., based on feedback from a prior iteration, or otherwise); the parametric update can be performed without further compilation. In some cases, a compiler generates a full binary program that does not need to be updated or otherwise modified for execution.

In some implementations, the servers 108 generate a schedule for executing programs, allocate computing resources in the computing system 101 according to the schedule, and delegate the programs to the allocated computing resources. The servers 108 can receive, from each computing resource, output data from the execution of each program. Based on the output data, the servers 108 may generate additional programs that are then added to the schedule, output data that is provided back to a user device 110, or perform another type of action.

In some implementations, all or part of the computing environment operates as a cloud-based quantum computing (QC) environment, and the servers 108 operate as a host system for the cloud-based QC environment. The cloud-based QC environment may include software elements that operate on both the user devices 110 and the computer system 101 and interact with each other over the wide area network 115. For example, the cloud-based QC environment may provide a remote user interface, for example, through a browser or another type of application on the user devices 110. The remote user interface may include, for example, a graphical user interface or another type of user interface that obtains input provided by a user of the cloud-based QC environment. In some cases the remote user interface includes, or has access to, one or more application programming interfaces (APIs), command line interfaces, graphical user interfaces, or other elements that expose the services of the computer system 101 to the user devices 110.

In some cases, the cloud-based QC environment may be deployed in a “serverless” computing architecture. For instance, the cloud-based QC environment may provide on-demand access to a shared pool of configurable computing resources (e.g., networks, servers, storage, applications, services, quantum computing resources, classical computing resources, etc.) that can be provisioned for requests from user devices 110. Moreover, the cloud-based computing systems 101 may include or utilize other types of computing resources, such as, for example, edge computing, fog computing, etc.

In an example implementation of a cloud-based QC environment, the servers 108 may operate as a cloud provider that dynamically manages the allocation and provisioning of physical computing resources (e.g., GPUs, CPUs, QPUs, etc.). Accordingly, the servers 108 may provide services by defining virtualized resources for each user account. For instance, the virtualized resources may be formatted as virtual machine images, virtual machines, containers, or virtualized resources that can be provisioned for a user account and configured by a user. In some cases, the servers 108 include a container management and execution system that is implemented, for example, using KUBERNETES® or another software platform for container management. In some cases, the cloud-based QC environment is implemented, for example, using OPENSTACK® or another software platform for cloud-based computing that provides virtual servers, or other virtual computing resources for users.

In some cases, the server 108 stores quantum machine images (QMI) for each user account. A quantum machine image may operate as a virtual computing resource for users of the cloud-based QC environment. For example, a QMI can provide a virtualized development and execution environment to develop and run programs (e.g., quantum programs or hybrid classical/quantum programs). When a QMI operates on the server 108, the QMI may engage either of the quantum processor units 102A, 102B, and interact with a remote user device (110B or 110C) to provide a user programming environment. The QMI may operate in close physical proximity to, and have a low-latency communication link with, the quantum computing systems 103A, 103B. In some implementations, remote user devices connect with QMIs operating on the servers 108 through secure shell (SSH) or other protocols over the wide area network 115.

In some implementations, all or part of the computing system 101 operates as a hybrid computing environment. For example, quantum programs can be formatted as hybrid classical/quantum programs that include instructions for execution by one or more quantum computing resources and instructions for execution by one or more classical resources. The servers 108 can allocate quantum and classical computing resources in the hybrid computing environment, and delegate programs to the allocated computing resources for execution. The quantum computing resources in the hybrid environment may include, for example, one or more quantum processing units (QPUs), one or more quantum simulators, or possibly other types of quantum resources. The classical computing resources in the hybrid environment may include, for example, one or more digital microprocessors, one or more specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), or other types of computing modules.

In some cases, the servers 108 can select the type of computing resource (e.g., quantum or classical) to execute an individual program, or part of a program, in the computing system 101. For example, the servers 108 may select a particular quantum processing unit (QPU) or other computing resource based on availability of the resource, speed of the resource, information or state capacity of the resource, a performance metric (e.g., process fidelity) of the resource, or based on a combination of these and other factors. In some cases, the servers 108 can perform load balancing, resource testing and calibration, and other types of operations to improve or optimize computing performance.

Each of the example quantum computing systems 103A, 103B shown in FIG. 1 can perform quantum computational tasks by executing quantum machine instructions (e.g., a binary program compiled for the quantum computing system). In some implementations, a quantum computing system can perform quantum computation by storing and manipulating information within quantum states of a composite quantum system. For example, qubits (i.e., quantum bits) can be stored in, and represented by, an effective two-level sub-manifold of a quantum coherent physical system. Qudits (i.e., quantum digits) represented by a multi-level quantum system providing a larger state space can be also defined by a qubit device. In some instances, quantum logic can be executed in a manner that allows large-scale entanglement within the quantum system. Control signals can manipulate the quantum states of individual qubits and the joint states of multiple qubits. In some instances, information can be read out from the composite quantum system by measuring the quantum states of the qubits. In some implementations, the quantum states of the qubits are read out by measuring the transmitted or reflected signal from auxiliary quantum devices that are coupled to individual qubits.

In some implementations, a quantum computing system can operate using gate-based models for quantum computing. For example, the qubits can be initialized in an initial state, and a quantum logic circuit comprised of a series of quantum logic gates can be applied to transform the qubits and extract measurements representing the output of the quantum computation. Individual qubits may be controlled by single-qubit quantum logic gates, and pairs of qubits may be controlled by two-qubit quantum logic gates (e.g., entangling gates that are capable of generating entanglement between the pair of qubits). In some implementations, a quantum computing system can operate using adiabatic or annealing models for quantum computing. For instance, the qubits can be initialized in an initial state, and the controlling Hamiltonian can be transformed adiabatically by adjusting control parameters to another state that can be measured to obtain an output of the quantum computation.

In some models, fault-tolerance can be achieved by applying a set of high-fidelity control and measurement operations to the qubits. For example, quantum error correcting schemes can be deployed to achieve fault-tolerant quantum computation. Other computational regimes may be used; for example, quantum computing systems may operate in non-fault-tolerant regimes. In some implementations, a quantum computing system is constructed and operated according to a scalable quantum computing architecture. For example, in some cases, the architecture can be scaled to a large number of qubits to achieve large-scale general purpose coherent quantum computing. Other architectures may be used; for example, quantum computing systems may operate in small-scale or non-scalable architectures.

The example quantum computing system 103A shown in FIG. 1 includes a quantum processing unit 102A and a control system 105A, which controls the operation of the quantum processing unit 102A. Similarly, the example quantum computing system 103B includes a quantum processing unit 102B and a control system 105B, which controls the operation of a quantum processing unit 102B. A quantum computing system may include additional or different features, and the components of a quantum computing system may operate as described with respect to FIG. 1 or in another manner.

In some instances, all or part of the quantum processing unit 102A functions as a quantum processor, a quantum memory, or another type of subsystem. In some examples, the quantum processing unit 102A includes a quantum circuit system. The quantum circuit system may include qubit devices, readout devices, and possibly other devices that are used to store and process quantum information. In some cases, the quantum processing unit 102A includes a QPU sublattice, and the qubit devices are implemented as circuit devices that include Josephson junctions, for example, in superconducting quantum interference device (SQUID) loops or other arrangements, and are controlled by radio-frequency signals, microwave signals, and bias signals delivered to the quantum processing unit 102A. In some cases, the quantum processing unit 102A includes an ion trap system, and the qubit devices are implemented as trapped ions controlled by optical signals delivered to the quantum processing unit 102A. In some cases, the quantum processing unit 102A includes a spin system, and the qubit devices are implemented as nuclear or electron spins controlled by microwave or radio-frequency signals delivered to the quantum processing unit 102A. The quantum processing unit 102A may be implemented based on another physical modality of quantum computing.

The quantum processing unit 102A may include, or may be deployed within, a controlled environment. The controlled environment can be provided, for example, by shielding equipment, cryogenic equipment, and other types of environmental control systems. In some examples, the components in the quantum processing unit 102A operate in a cryogenic temperature regime and are subject to very low electromagnetic and thermal noise. For example, magnetic shielding can be used to shield the system components from stray magnetic fields, optical shielding can be used to shield the system components from optical noise, thermal shielding and cryogenic equipment can be used to maintain the system components at a controlled temperature, etc.

In some implementations, the example quantum processing unit 102A can process quantum information by applying control signals to the qubits in the quantum processing unit 102A. The control signals can be configured to encode information in the qubits, to process the information by performing quantum logic gates or other types of operations, or to extract information from the qubits. In some examples, the operations can be expressed as single-qubit quantum logic gates, two-qubit quantum logic gates, or other types of quantum logic gates that operate on one or more qubits. A quantum logic circuit, which includes a sequence of quantum logic operations, can be applied to the qubits to perform a quantum algorithm. The quantum algorithm may correspond to a computational task, a hardware test, a quantum error correction procedure, a quantum state distillation procedure, or a combination of these and other types of operations.

In some implementations, the example quantum processing unit 102 is a modular quantum processing unit that includes multiple quantum processor modules. For example, the quantum processing unit 102 may include a two-dimensional or three-dimensional array of quantum processor modules, and each quantum processor module may include an array of quantum circuit devices. In some cases, the quantum processor modules in a modular quantum processing unit are supported on a common substrate, and they are interconnected through circuitry (e.g., superconducting circuitry) on the common substrate.

In some instances, each of the quantum processor modules can include a superconducting quantum integrated circuit (QuIC) that includes one or more quantum circuit devices and superconductive lines that connect the one or more quantum circuit devices. For instance, each quantum processor module may include qubit devices, readout resonator devices, tunable-frequency coupler devices, capacitive coupler devices, or other quantum circuit devices. Each quantum processor module may include flux bias control lines, microwave drive lines, readout signal lines, or other types of control lines for providing control signals to respective quantum circuit devices and for collecting readout samples from the respective quantum circuit devices. In some implementations, quantum processor modules in a modular quantum processing unit can be coupled to each other by one or more inter-chip coupler devices.

In some implementations, each of the quantum computing systems 103A, 103B includes multiple quantum processing units 102. Each of the quantum processing units 102 may be enclosed in distinct thermal environments (e.g., separated dilution refrigerator systems). In some implementations, quantum processing units 102 in separate quantum computing systems 103 are communicably coupled together through an interconnection. In some instances, an interconnection between quantum processing units in separate dilution refrigerator systems includes a communication link, e.g., an optical link, a superconducting link, or another type of communication link providing a connection between qubit devices in separate quantum processing units housed in separate thermal environments. In some instances, an interconnection may also include other hardware associated with the communication link, e.g., signal generation, conversion, and delivery units.

The example control system 105A includes controllers 106A and signal hardware 104A. Similarly, control system 105B includes controllers 106B and signal hardware 104B. All or part of the control systems 105A, 105B can operate in a room-temperature environment or another type of environment, which may be located near the respective quantum processing units 102A, 102B. In some cases, the control systems 105A, 105B include classical computers, signaling equipment (microwave, radio, optical, bias, etc.), electronic systems, vacuum control systems, refrigerant control systems, or other types of control systems that support operation of the quantum processing units 102A, 102B.

The control systems 105A, 105B may be implemented as distinct systems that operate independent of each other. In some cases, the control systems 105A, 105B may include one or more shared elements; for example, the control systems 105A, 105B may operate as a single control system that operates both quantum processing units 102A, 102B. Moreover, a single quantum computer system may include multiple quantum processing units, which may operate in the same controlled (e.g., cryogenic) environment or in separate environments.

The example signal hardware 104A includes components that communicate with the quantum processing unit 102A. The signal hardware 104A may include, for example, waveform generators, amplifiers, digitizers, high-frequency sources, DC sources, AC sources, etc. The signal hardware may include additional or different features and components. In the example shown, components of the signal hardware 104A are adapted to interact with the quantum processing unit 102A. For example, the signal hardware 104A can be configured to operate in a particular frequency range, configured to generate and process signals in a particular format, or the hardware may be adapted in another manner.

In some instances, one or more components of the signal hardware 104A generate control signals, for example, based on control information from the controllers 106A. The control signals can be delivered to the quantum processing unit 102A during operation of the quantum computing system 103A. For instance, the signal hardware 104A may generate signals to implement quantum logic operations, readout operations, or other types of operations. As an example, the signal hardware 104A may include arbitrary waveform generators (AWGs) that generate electromagnetic waveforms (e.g., microwave or radio-frequency) or laser systems that generate optical waveforms. The waveforms or other types of signals generated by the signal hardware 104A can be delivered to devices in the quantum processing unit 102A to operate qubit devices, readout devices, bias devices, coupler devices, or other types of components in the quantum processing unit 102A.

In some instances, the signal hardware 104A receives and processes signals from the quantum processing unit 102A. The received signals can be generated by the execution of a quantum program on the quantum computing system 103A. For instance, the signal hardware 104A may receive signals from the devices in the quantum processing unit 102A in response to readout or other operations performed by the quantum processing unit 102A. Signals received from the quantum processing unit 102A can be mixed, digitized, filtered, or otherwise processed by the signal hardware 104A to extract information, and the information extracted can be provided to the controllers 106A or handled in another manner. In some examples, the signal hardware 104A may include a digitizer that digitizes electromagnetic waveforms (e.g., microwave or radio-frequency) or optical signals, and a digitized waveform can be delivered to the controllers 106A or to other signal hardware components. In some instances, the controllers 106A process the information from the signal hardware 104A and provide feedback to the signal hardware 104A; based on the feedback, the signal hardware 104A can in turn generate new control signals that are delivered to the quantum processing unit 102A.

In some implementations, the signal hardware 104A includes signal delivery hardware that interfaces with the quantum processing unit 102A. For example, the signal hardware 104A may include filters, attenuators, directional couplers, multiplexers, diplexers, bias components, signal channels, isolators, amplifiers, power dividers, and other types of components. In some instances, the signal delivery hardware performs preprocessing, signal conditioning, or other operations to the control signals to be delivered to the quantum processing unit 102A. In some instances, signal delivery hardware performs preprocessing, signal conditioning, or other operations on readout signals received from the quantum processing unit 102A.

The example controllers 106A communicate with the signal hardware 104A to control operation of the quantum computing system 103A. The controllers 106A may include classical computing hardware that directly interfaces with components of the signal hardware 104A. The example controllers 106A may include classical processors, memory, clocks, digital circuitry, analog circuitry, and other types of systems or subsystems. The classical processors may include one or more single- or multi-core microprocessors, digital electronic controllers, special purpose logic circuitry, e.g., an FPGA (field programmable gate array) or an ASIC (application specific integrated circuit), or other types of data processing apparatus. The memory may include any type of volatile or non-volatile memory or another type of computer storage medium. The controllers 106A may also include one or more communication interfaces that allow the controllers 106A to communicate via the local network 109 and possibly other channels. The controllers 106A may include additional or different features and components.

In some implementations, the controllers 106A include memory or other components that store quantum state information, for example, based on qubit readout operations performed by the quantum computing system 103A. For instance, the states of one or more qubits in the quantum processing unit 102A can be measured by qubit readout operations, and the measured state information can be stored in a cache or other type of memory system in one or more of the controllers 106A. In some cases, the measured state information is subsequently used in the execution of a quantum program, a quantum error correction procedure, a quantum processing unit (QPU) calibration or testing procedure, or another type of quantum process.

In some implementations, the controllers 106A include memory or other components that store a quantum program containing quantum machine instructions for execution by the quantum computing system 103A. In some instances, the controllers 106A can interpret the quantum machine instructions and perform hardware-specific control operations according to the quantum machine instructions. For example, the controllers 106A may cause the signal hardware 104A to generate control signals that are delivered to the quantum processing unit 102A to execute the quantum machine instructions.

In some instances, the controllers 106A extract qubit state information from qubit readout signals, for example, to identify the quantum states of qubits in the quantum processing unit 102A or for other purposes. For example, the controllers may receive the qubit readout signals (e.g., in the form of analog waveforms) from the signal hardware 104A, digitize the qubit readout signals, and extract qubit state information from the digitized signals. In some cases, the controllers 106A compute measurement statistics based on qubit state information from multiple shots of a quantum program. For example, each shot may produce a bitstring representing qubit state measurements for a single execution of the quantum program, and a collection of bitstrings from multiple shots may be analyzed to compute quantum state probabilities.

In some implementations, the controllers 106A include one or more clocks that control the timing of operations. For example, operations performed by the controllers 106A may be scheduled for execution over a series of clock cycles, and clock signals from one or more clocks can be used to control the relative timing of each operation or groups of operations. In some implementations, the controllers 106A may include classical computing resources that perform some or all of the operations of the servers 108 described above. For example, the controllers 106A may operate a compiler to generate binary programs (e.g., full or partial binary programs) from source code; the controllers 106A may include an optimizer that performs classical computational tasks of a hybrid classical/quantum program; the controllers 106A may update binary programs (e.g., at runtime) to include new parameters based on an output of the optimizer, etc.

The other quantum computer system 103B and its components (e.g., the quantum processing unit 102B, the signal hardware 104B and controllers 106B) can be implemented as described above with respect to the quantum computer system 103A; in some cases, the quantum computer system 103B and its components may be implemented or may operate in another manner.

In some implementations, the quantum computer systems 103A, 103B are disparate systems that provide distinct modalities of quantum computation. For example, the computer system 101 may include both an adiabatic quantum computer system and a gate-based quantum computer system. As another example, the computer system 101 may include a QPU sublattice-based quantum computer system and an ion trap-based quantum computer system. In such cases, the computer system 101 may utilize each quantum computing system according to the type of quantum program that is being executed, according to availability or capacity, or based on other considerations.

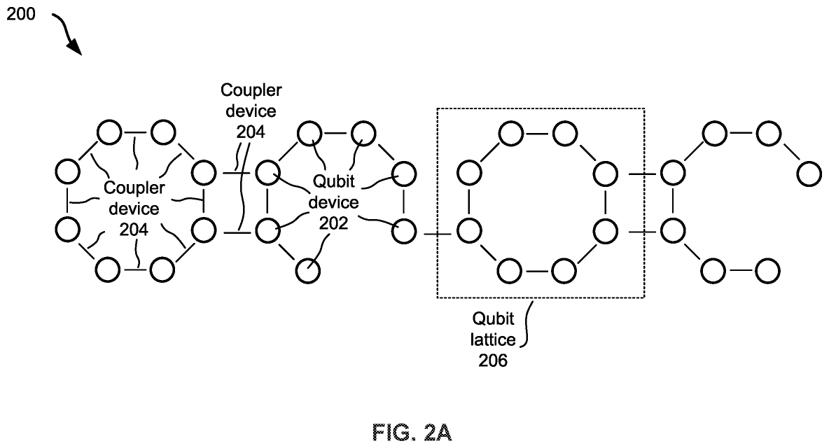

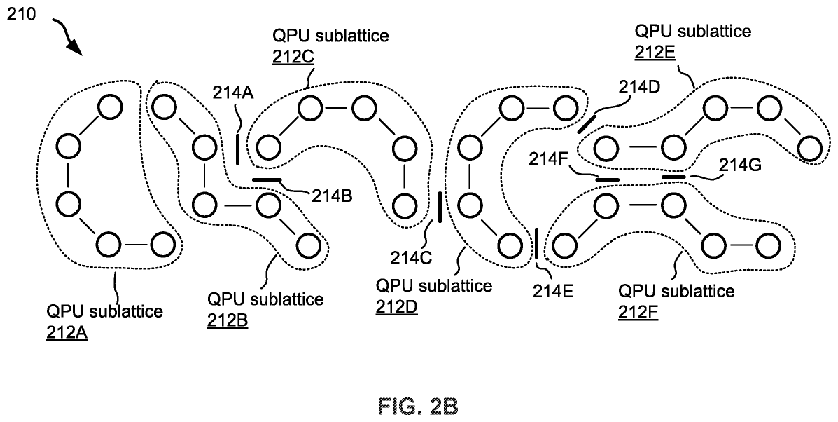

FIG. 2A is a schematic diagram showing aspects of an example quantum processing unit 200 of a hybrid computing system. The example quantum processing unit 200 includes a superconducting quantum circuit, which includes qubit devices 202, coupler devices 204, and other quantum circuit devices. As shown in FIG. 2A, a subset of qubit devices 202 and a subset of coupler device 204 form a qubit lattice 206 in which each qubit device 202 in an octagonal lattice is coupled to at least one neighboring qubit device 202 through a coupler device 204. Generally, a quantum processing unit may include any number of qubit devices, any number of qubit lattices, and a qubit lattice may have any number of qubit devices in any geometric configuration or spatial arrangement. In certain implementations, the quantum processing unit 200 may include additional or different components, and the components may be arranged as shown or in another manner.

In some implementations, qubit devices 202 are implemented as a tunable-frequency qubit devices, e.g., tunable-frequency transmon qubit devices, tunable-frequency flux qubit devices, tunable-frequency flatsonium qubit devices, tunable-frequency fluxonium qubit devices, or other types of tunable-frequency qubit devices. In some instances, a qubit device may be implemented as a fixed-frequency qubit device. In some implementations, a qubit lattice 206 may be coupled to two neighboring qubit lattices 206 residing on the same plane or on different planes. For example as shown in FIG. 2A, a qubit lattice 206 may be coupled to neighboring qubit lattices 206 through one or more qubit devices 202. In some implementations, each of the coupler devices 204 is a tunable-frequency coupler device which can be controlled to allow electromagnetic coupling or decoupling between the neighboring qubit devices 202. For example, tunable-coupler devices may be deactivated to segment qubit devices into QPU sublattices. In some implementations, a topology of QPU lattices in a quantum processing unit can be tuned, updated or otherwise changed by activating or disactivating the tunable-frequency coupler devices. In some instances, the coupler devices 204 may include one or more coupler elements providing a fixed coupling between two neighboring qubit devices 202.

In the example quantum processing unit 200 shown in FIG. 2A, each of the qubit devices 202 can define a single bit of quantum information. Each of the qubit devices 202 has two eigenstates that are used as computational basis states, and each qubit device can transition between its computational basis states or exist in an arbitrary superposition of its computational basis states. In some examples, the two lowest energy levels (e.g., the ground state |0 [symbol] and the first excited state |1 [symbol] ) of each qubit device are defined as a qubit and used as computational basis states for quantum computation. In some examples, higher energy levels (e.g., a second excited state |2 [symbol] or a third excited state |3 [symbol] ) are also defined by a qubit device, and may be used for quantum computation in some instances.

Qubits defined by respective qubit devices can be manipulated by control signals, or read by readout signals, generated by a control system (e.g., the control system 105). The qubit devices can be controlled individually, for example, by delivering control signals to the respective qubit devices. In some cases, the quantum processing unit 200 includes readout devices that can detect the qubits of the qubit devices 202, for example, by interacting directly with the respective qubit devices 202.

In some examples, a qubit device 202, when implemented as a tunable-frequency qubit device which has a transition frequency that can be tuned, includes a quantum circuit loop (e.g., a SQUID loop). The quantum circuit loop receives a magnetic flux that tunes the transition frequency of the tunable-frequency qubit device. In some instances, the transition frequency can be tuned within a range of qubit operating frequencies. The quantum circuit loop may include two Josephson junctions, and the tunable-frequency qubit device may also include a shunt capacitor connected in parallel with each of the two Josephson junctions. In some examples, a transition frequency, which defines a qubit operating frequency of a tunable-frequency qubit device, is tunable, for example, by application of a magnetic flux. A qubit operating frequency of the tunable-frequency qubit device may be defined at least in part by Josephson energies of the two Josephson junctions, a capacitance of the shunt capacitor, and a magnetic flux threading the quantum circuit loop.

In some implementations, a coupler device 204, when implemented as a tunable-frequency coupler device, may receive control signals to enable electromagnetic coupling or decoupling between the qubit devices 202. When two or more qubit devices are coupled, the two or more qubit devices can be used to perform multi-qubit quantum logic gates (e.g. perform quantum logic gates or operations proscribed by a quantum circuit).

In some implementations, the quantum processing unit 200 is a modular quantum processing unit. In some implementations, a modular quantum processing unit includes a two-dimensional or three-dimensional array of quantum processor modules that are interconnected to each other. Each of the quantum processor modules in a modular quantum processing unit may include a superconducting quantum integrated circuit (QuIC). The superconducting QuIC can include quantum circuit devices, for example, qubit devices (e.g., transmon devices, fluxonium devices, or other types of superconducting qubit devices), coupler devices (e.g., capacitive coupler device, tunable-frequency coupler device, or others), readout devices, or other types of quantum circuit devices that are used for quantum information processing in the modular quantum processing unit. The superconducting QuIC of each of the quantum processor modules may include one or more Josephson junctions, capacitors, inductors, and other types of circuit elements. Each of the quantum processor modules may include a two-dimensional or three-dimensional array of quantum circuit devices. In some instances, the modular quantum processing unit and each of the quantum processor modules may be implemented in another manner.

In some cases, neighboring quantum processor modules in a modular quantum processing unit are interconnected by superconducting circuitry which includes inter-chip coupler devices. For example, as shown in FIG. 2A, two neighboring qubit lattices 206 may reside on two separate quantum processor modules and the coupler devices 204 can be implemented as inter-chip coupler devices that enable coupling of qubit devices in distinct quantum processor modules. In some implementations, inter-chip coupler devices are tunable. In some instances, coupling between two neighboring quantum processor modules may be activated or deactivated by communicating control signals to the inter-chip coupler devices, for example, when segmenting qubit devices from quantum processor modules to form QPU sublattices for performing operations in the example process 400 in FIG. 4.

In some implementations, the quantum computing system includes multiple quantum processing units 200 that are separately enclosed in distinct thermal environments (e.g., dilution refrigerator systems). For instance, each QPU may be housed in a separate dilution refrigerator that includes multiple thermal stages that create a very low temperature environment (e.g., T<120 K) for the QPU. As shown in FIG. 2A, two neighboring qubit lattices 206 may reside on two quantum processing unit 200 in two separate dilution refrigerator systems. In this case, coupler devices 204 represent systems and interconnections between two quantum processing units 200 in two separate dilution refrigerator systems. For example, the coupler device 204 includes an optical link which can carry signals in the optical regime to control qubit devices, drive qubit devices, and generate entanglement between qubit devices in separated dilution refrigerator systems. In this case, the coupler device 204 includes optical components (e.g., optical fibers) and signal conversion/delivery units. In some instances, the coupler device 204 includes a superconducting link which can carry signals in the RF or microwave regime to control qubit devices, drive qubit devices, and generate entanglement between qubit devices in separated dilution refrigerator systems. In this case, the coupler device 204 includes superconducting circuit components (e.g., superconducting cabling) and signal delivery units. In some implementations, the coupler devices 204 can be controlled to activate or deactivate coupling between qubit devices in separate dilution refrigerator systems, for example, when segmenting qubit devices from quantum processing units to form QPU sublattices for performing operations in the example process 400 in FIG. 4.

FIG. 2B is a schematic diagram showing an example segmentation of an example quantum processing unit 210 shown in FIG. 2A to form QPU sublattices for parallel data processing in a machine learning algorithm. The example quantum processing unit 210 is implemented as the example quantum processing unit 200 as shown in FIG. 2A. The example quantum processing unit 210 is segmented into multiple QPU sublattices 212. Segmentation of the quantum processing unit 210 may be determined by available quantum computing resources (e.g., a total number of qubit devices and quantum processing units), a number of input parameters, model parameters and hyperparameters of a machine learning model, target fidelity or conversely error rates of the hardware, target expressibility of the circuit, or another performance metric.

In some implementations, segmenting quantum circuit devices into multiple QPU sublattices 212 can be achieved by selectively decoupling two neighboring qubit devices on the same quantum processor module, two qubit devices on different quantum processor modules of the same modular quantum processing unit, or two qubit devices in different quantum processing units in separate quantum computing systems. In some instances, segmenting quantum circuit devices may be implemented in another manner. In some instances, control parameters of control signals applied on one or more coupler devices 204 can be tuned to decouple two neighboring qubit devices. For example, a coupler device 204 can be tuned to decouple two neighboring qubit devices within the same qubit lattice 206; or a coupler device can be tuned to decouple two neighboring qubit devices within two neighboring qubit lattices. For example, two neighboring qubit devices are logically decoupled by choosing not to enact any control pulses known to interact the qubits (e.g., quantum logic gates). In this case, the physical coupling would remain, and as well as the chance of parasitic (unwanted) couplings or interactions. The parasitic couplings can act as sources of errors, and advanced compilation techniques can be used to adjust for such errors.

As shown in FIG. 2B, the example segmentation of the quantum processing unit 210 can be performed by tuning the coupler devices 214A, 214B, 214C, 214D, 214E, 214F, and 214G. In the example shown in FIG. 2B, the quantum processing unit 210 has been segmented into six distinct and separate QPU sublattices 212A, 212B, 212C, 212D, 212E, and 212F. In certain instances, the quantum processing unit 210 may be segmented in a different manner by tuning one or more different coupler devices 204 to form a different number of QPU sublattices.

In some instances, QPU sublattices may have different topologies, for example, a different subset of qubit devices with a different connectivity, and each of the subset of qubit devices may include a different number of qubit devices. In some implementations, segmentation of qubit devices in a quantum processing unit to form QPU sublattices and topologies of the QPU sublattices after segmentation is determined and optimized according to device parameters of the coupler devices 204, qubit devices 202, and other quantum circuit devices. Topologies of QPU sublattices may be optimized by optimizing an objective function or multiple objective functions, e.g. by maximizing the number of embeddable sub-lattices with desired topology, such as linear chains; by maximizing the mean or other statistical measure over gate fidelities for the target quantum circuit, such as a Born machine, where each gate fidelity is previously (or periodically) measured by techniques such as standard randomized benchmarking, cross-entropy benchmarking, cycle benchmarking, or some other method, and is unique to each qubit; and by maximizing effective isolation or minimizing crosstalk between qubit devices. In some implementations, segmenting quantum circuit devices in a quantum processing unit to form QPU sublattices is determined and optimized by operation of a classical computing resource (e.g., the server 108 in FIG. 1).

In some implementations, each QPU sublattice 212 may be used as a node in a layer of a machine learning model (e.g., a neural network). A machine learning model, e.g., a neural network, may include multiple layers and each layer may include one or more nodes. In some instances, each QPU sublattice 212 can be used as a feature detector which takes a subset of input parameters from an input image or from readout samples of nodes in a previous layer. A filtered subset of the input image (e.g., m input parameters) can be run through a single feature detector and an activation parameter from the single feature detector (e.g., a single QPU sublattice 212) can be recorded. In other words, when a QPU sublattice 212 with n qubit devices 202 takes m input parameters (e.g., n<m, n>m, or n=m) multiple times, it can produce a feature map. Each of the QPU sublattices 212 can produce a feature map. Inputs may be ranged in sequence or in parallel. This is independent of whether it is then used to generate a feature map by filtered application of inputs iteratively.

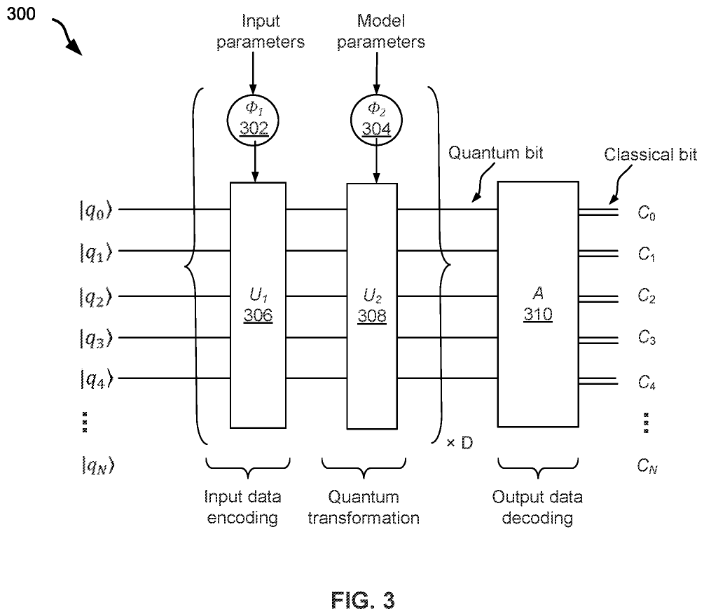

FIG. 3 is a schematic diagram showing aspects of an example quantum logic circuit 300. The example quantum logic circuit 300 as shown in FIG. 3 is performed on qubit devices in a QPU sublattice of a quantum processing unit. The example quantum logic circuit 300 can be performed on different QPU sublattices to perform a machine learning algorithm (e.g., the machine learning process 400 shown in FIG. 4). The QPU sublattice where the example quantum logic circuit 300 is executed can be implemented as the QPU sublattice 212A, 212B, 212C, 212D, 212E, 212F in FIG. 2B or in another manner. In some instances, the example quantum logic circuit 300 shows a single quantum layer participation in a training process of a machine learning model. The example quantum logic circuit 300 may include additional or different features, and the components may be arranged as shown or in another manner.

As shown in FIG. 3, the example quantum logic circuit 300 includes multiple unitary transformations. In particular, the example quantum logic circuit 300 includes a first unitary transformation U₁ represented by an encoder function 306, a second unitary transformation U₂ represented by a quantum transformation function 308, and an operator A.

In some implementations, the first unitary transformation U₁ is used for performing an input data encoding operation. The first unitary transformation U₁ represented by the encoder function 306 can include one or more parametrically activated quantum logic gates and other types of quantum logic gates. A parametrically activated quantum logic gate in the first unitary transformation U₁ is defined by one or more quantum logic gate parameters and can be performed on one or more qubits defined by one or more qubit devices in a QPU sublattice. For example, the first unitary transformation U₁ in the encoder function 306 may include one or more single-qubit quantum logic gates which are applied to one or more qubits defined by one or more qubit devices in the QPU sublattice. For another example, the first unitary transformation U₁ in the encoder function 312 may include one or more two-qubit or multi-qubit quantum logic gates which are applied to a pair or a set of qubits defined by coupled/entangled qubit devices in the QPU sublattice. In some instances, encoding of the transformed input parameters may be achieved using other types of parametrically activated quantum logic gates to configure respective initialized states for respective qubit devices.

In some implementations, the first unitary transformation U₁ in the encoder function 306 can be defined based on the number of input parameters, and the degrees of freedom in the quantum computing system. In some instances, multiple input parameters may be encoded on one or more qubits defined by one or more qubit devices of the QPU sublattice. For example, a single rotation gate is used for encoding a single input parameter on a single qubit defined by a qubit device. For another example, two input parameters can be encoded on a single qubit defined by a single qubit device using two different rotation gates or by encoding on amplitude and phase.

In some implementations, input parameters can be encoded using multi-qubit quantum logic gates that afford more degrees of freedom and do not cause information overlap. For example, input parameters may be encoded using multi-qubit quantum logic gates according to the available degrees of freedom in the quantum system (e.g., a QPU sublattice). In some instances, a multi-qubit quantum logic gate may be an entangling quantum logic gate. For example, an n-qubit system with n qubit devices operates on the unitary group SU(2ⁿ) with 2²ⁿ−1 degrees of freedom and could encode 2²ⁿ−1 real input parameters. In some instances, the physically programmable degrees of freedom in the effective two-level sub-manifold of a quantum coherent physical system limits the ability to effectively encode data in this way.

The second unitary transformation U₂ is used for encoding model parameters of the machine learning model and performing quantum transformation. The second unitary transformation U₂ represented by the quantum transformation function 308 is performed on the qubits defined by the qubit devices which are previously initialized by the encoder function 306. The second unitary transformation U₂ may include one or more parametrically activated quantum logic gates and other types of quantum logic gates. A parametrically activated quantum logic gate in the second unitary transformation U₂ is defined by one or more quantum logic gate parameters. In certain instances, the second unitary transformation U₂ in the quantum transformation function 308 includes one or more single-qubit quantum logic gates which are applied to one or more qubits defined by one or more qubit devices in the QPU sublattice. In some instances, the second unitary transformation U₂ in the quantum transformation function 308 includes one or more entangling two-qubit or multi-qubit quantum logic gates, which are applied to a pair or a set of qubits defined by coupled/entangled qubit devices in the QPU sublattice.

In some implementations, input parameters are translated (by a translation function 302) into a first set of quantum logic gate parameters of the first unitary transformation U₁ in the quantum transformation function 306 and model parameters are translated (by a translation function 304) into a second set of quantum logic gate parameters of the second unitary transformation U₂ in the quantum transformation function 308. Each of the translation processes performed on the input parameters and the model parameters is a classical computing process which can be performed by operation of a classical processing unit (e.g., CPU or GPU) of a control system of a quantum computing resource (e.g., the control system 105 of the quantum computing system 103 in FIG. 1). During the translation processes, the input parameters which can be sampled from a training set (e.g., from a portion of an input image or in another manner) and can be translated by the first translation function (ϕ₁) 302 into translated input parameters, which parameterize the encoder function 306. The translated input parameters are then encoded into quantum states of the qubit devices in the QPU sublattice during an input data encoding operation. In some instances, the input data encoding operation to encode the translated input parameters into the quantum states is a quantum computing process which can be performed on quantum computing resources (e.g., the QPU sublattices 212 in the QPU 210). Similarly, the model parameters can be translated by the second translation function (ϕ₂) 304. The output quantum states produced from the encoder function 306 can be further prepared by the quantum transformation function 308 parameterized by the translated model parameters.

The first unitary transformation U₁ in the encoder function 306 and the second unitary transformation U₂ in the quantum transformation function 308 can be repeated in the example quantum logic circuit 300. The number of iterations of the first and second unitary transformations U₁ and U₂ in the example quantum logic circuit 300 in FIG. 3 is the depth which is noted as D. In other words, the quantum logic circuit 300 includes a number (D) of iterations of the first and second unitary transformations U₁ and U₂. Iterations of the first and second unitary transformations are performed over time on a single QPU sublattice (as shown from left to right in FIG. 3). Iterations of the first and second unitary transformations act on quantum information in the high-dimension Hilbert space to maximize or otherwise increase the utilization of quantum entanglement resources which are difficult to simulate classically.

In some implementations, respective first unitary transformations U₁ across the iterations receive the same input parameters. In other words, input parameters can be re-uploaded into the quantum logic circuit 300 multiple times through the iterations of the first unitary transformations U₁. In some instances, re-uploading of the input parameters multiple times enables the use of the high-dimension Hilbert space afforded by the quantum processing unit.

In some implementations, respective second unitary transformations U₂ in the iterations may be identical to each other. In some implementations, respective second unitary transformations U₂ in the iterations receive distinct sets of model parameters. Each of the distinct sets of model parameters may include a different number of model parameters. For example, when the depth of a machine learning model executed on a QPU sublattice is D, the total number of distinct sets of model parameters for the quantum logic circuit 300 is D.

In some implementations, the available operations and connectivity of the QPU sublattice affects the first unitary transformation U₁ in the encoder function 306, and the second unitary transformation U₂ in the quantum transformation function 308. For example, the respective first and second unitary transformations U₁, U₂ may be composed of only operations able to be enacted by the control systems (e.g. 105A, 105B) of the quantum computing systems 103 and also respecting the connectivity of the QPU or QPU sublattice (e.g. 212A, 212B, etc). This approach is known as a “hardware efficient ansatz”.

In some implementations, the second unitary transformation U₂ in the quantum transformation function 308, and also the overall changes in the structures of iterations of the first and second unitary transformations U₁, U₂ in the example quantum logic circuit 300, is defined to maximize or otherwise increase the use of the available quantum entanglement and expressibility, e.g., to maximally mix and combine the input information in the Hilbert space of the quantum system such that outputs benefit. In some instances, the second unitary transformation U₂ in the quantum transformation function 308 is constructed of hardware efficient patterns of entangling quantum logic gates (e.g., layers of CNOTs on nearest neighbors) or in another manner.

In some implementations, the quantum computation part of the example quantum logic circuit 300 is executed on a QPU sublattice including multiple qubit devices. In certain instances, the QPU sublattice may include one or more coupler devices that are used to couple two neighboring qubit devices. In some implementations, each of the qubit devices includes a tunable-frequency qubit device or a fixed-frequency qubit device; the coupler devices are tunable-frequency coupler devices or a fixed-frequency coupler element (e.g., a capacitor). In some implementations, the qubit device and the coupler device may be implemented as the qubit device 202 and the coupler device 204 in the QPU sublattice 212 in the QPU 210 as shown in FIG. 2B.

The input parameters and the model parameters in FIG. 3 can be defined when the first and second unitary transformations U₁, U₂ in the encoder function 306 and the quantum transformation function 308 are defined. In some instances, values of the input parameters can be initialized, for example, by sampling from a portion of input data; and the model parameters can be initialized randomly. In certain instances, values of the model parameters can be initialized by a previously obtained initial condition (e.g., a “good guess”) or in another manner. For example, in transfer learning, a previously existing neural network can be used when it is expected to have a similar overall function. In some examples, by initializing the values of the model parameters according to an initial condition can reduce the overall training time. In some implementations, the input parameters and the model parameters are updated toward the goal (e.g., to minimize an objective function or another goal) when an iterative algorithm is implemented in a close loop, e.g., with respect to operations in the example process 400 shown in FIG. 4.

In some instances, the one or more quantum logic gate parameters of the one or more parametrically activated quantum logic gates in the first unitary operation U₁ are translated from the input parameters. In some instances, the first translation function (ϕ₁) 302 that applied on the input parameters is determined according to a range of the input parameters and an available range in the quantum logic gate parameters. In some instances, the first translation function (ϕ₁) 302 in the iterations are identical. In some instances, the first translation functions (ϕ₁) 302 associated with the iterations of the first unitary transformations U₁ may be different for the same input parameters. The first translation functions ϕ₁ associated with the iterations of the first unitary transformations U₁ for different input parameters at different layers may differ in a coefficient of a rotation, direction/axis of rotation, or in another manner. In some instances, after the input data encoding operation, the one or more input parameters are embedded into the QPU sublattice.

In some implementations, the encoder function 306 includes only controlled Z-rotation operations. For example, the first unitary transformation U₁ in the encoder function 306 includes parameterized rotation gates applied to respective qubits defined by respective qubit devices in a QPU sublattice, e.g., five RZ gates are applied on the five qubit devices 202 in the QPU sublattice 212. In this case, the input parameters are encoded in the QPU sublattice by performing the controlled Z-rotation operations at certain angles (e.g., the qubit device 202 of the QPU sublattice 212). For example, when input parameters p arein the range of [0, 2π], e.g., p∈[0, 2π], the input parameters p can be directly used as angular parameters for controlled Z-rotation operations applied to qubits defined by the qubit devices in the QPU sublattice on hardware that supports a continuous RZ(θ) gate. In this case, the input parameters are the quantum logic gate parameters; and the first translation function 302, in this case, is θ=p. For another example, when normalized input parameters p are in a range of [0, 1], e.g., p∈[0, 1], the normalized input parameters p may be mapped onto the rotation about the Z-axis applied on the qubits defined by the qubit devices, e.g., RZ(θ), for θ∈[0, 2π). In this case, the first translation function 302, in this case, is θ=p·π. In this example, the decision is made to avoid the angular range θ∈(π, 2π) to separate effects of p=0 from p=1 in the phase space.

In some implementations, each input parameter can be mapped to multiple different quantum logic gate parameters located in different places in the quantum logic circuit to realize data re-uploading and to gain the greatest expressivity from the data that is possible.

In some instances, the one or more quantum logic gate parameters of a parametrically activated quantum logic gate in the second unitary transformation U₂ are translated from the model parameters. This is specifically a quantum model, and so the embodiment of the model that is ready to receive new input data and perform the machine learning task, like classification, is (i) the total structure of the example quantum logic circuit 300, including all iterations of the first and second unitary transformations U₁ and U₂, and the operator A; and (ii) the specific values of the model parameters after being translated by the second translation function ϕ₂ 304, which are the quantum logic gate parameters of the second unitary transformation U₂ during the quantum transformation operation. Execution of the model then requires specific values of the input parameters which can be translated by the first translation function ϕ₁ 302 for the purpose of generating a specific prediction or other output for that input data.

In some implementations, the second unitary transformation U₂ in the quantum transformation function 308 includes entangling quantum logic gates to allow the input information, for example, from the output of the first unitary transformation U₁ in the encoder function 306 to interact. The entangling quantum logic gates in the second unitary transformation U₂ are configured to generate the intended result with high accuracy. In some instances, the encoder function 306 may include multi-qubit quantum logic gates. In some cases, the output of the encoder function 306 constitutes separable states (e.g., in which the total information is not entangled or interacting).

In some instances, second translation functions 304 associated to the second unitary transformations U₂ across the iterations may receive independent model parameters on each iteration. This can be distinct from first translation functions 302 associated to the first unitary transformations U₁, which receive the same input parameters on each iteration. For example, a first unitary transformation U₁ in an encoder function 306 may include a rotation gate applied on a qubit defined by a single qubit device. Rotation gates of the first unitary transformation U₁ in three iterations may have different rotation axes, e.g., RX, RY, and RZ. In this case, the same input parameter (input) can be re-uploaded into the qubit device and encoded by RX(input), RY(input), RZ(input) across 3 iterations. For another example, a first unitary transformation U₁ in an encoder function 306 may include a rotation gate applied on a qubit defined by a single qubit device. Rotation gates of the first unitary transformation U₁ in three iterations may have different coefficients. In this case, the same input parameter (input) can be re-uploaded into the qubit device and encoded by RX(input), RX(input/2), RX(input/4) across the three iterations.

In some implementations, a quantum logic circuit in the machine learning model that is executed on a single QPU sublattice includes multiple unitary transformations and translation functions. In some instances, replications of the input data encoding and quantum transformation operations (e.g., the first unitary transformation and the first translation function associated with the first unitary transformation, the second unitary transformation, and the second translation function associated with the second unitary transformation) can be patterned but may differ (slightly different connectivity, different rotation gates, different multipliers on angles, etc.). However, each iteration of the quantum logic circuit in the training process may use the exact same quantum logic circuit (e.g., the example quantum logic circuit 300 in FIG. 3); the process may sweep over the training input parameters and then change/update the model parameters for improving the output accuracy.

In some implementations, outputs from the second unitary transformation U₂ in the last iteration are further transformed by an operator A 310, and readout samples are obtained by performing measurements on one or more qubit devices of the QPU sublattice during an output data decoding operation. In some implementations, each of the output quantum states of the qubit devices in the QPU sublattice is measured. The operator A 310 is used for changing the measurement basis or for performing a pre-measurement transformation. In some instances, the operator A 310 includes a sequence of quantum logic gates. For example, the operator A 310 includes a set of specific single-qubit rotations. For another example, the operator A 310 includes identity gates or other types of quantum logic gates.

In some instances, the operator A 310 includes readout measurements on all or a subset of qubit devices in the QPU sublattice at the output of the sequence of quantum logic gates. Outputs from the readout measurements in the operator A 310 include classical information in a form of a simple bitstring or an array 0's and 1's. In some instances, the operator A 310 includes classical post-processing after quantum measurement, such as readout error mitigation. Readout error mitigation is designed to remove biases or correlations in the QPU output that may adversely impact the machine learning model accuracy. In some instances, readout error mitigation may process quantum information (e.g., quantum bits, prior to the readout measurement in the operator A 310), or classical information (e.g., classical bits, after the readout measurement in the operator A 310). In some implementations, the quantum information is processed to generate redundancy that improves readout fidelity. Examples to use readout error mitigation to process quantum information are described in the publication entitled “Active Readout-error Mitigation” by Hicks et al. (Phys. Rev. A 105, 012419). In some instances, the classical information can be processed, for example by multiplying a matrix that is the inverse of observations used to calibrate biases and correlations prior to execution of the machine learning algorithm. In some instances, the classical information undergoes probabilistic data processing such as Bayesian unfolding. Examples to process the classical information are described in the publication entitled “Unfolding Quantum Computer Readout Noise” by Nachman et al. (npj Quantum Information, vol. 6, Article number: 84, 2020). In some instances, the classical information is transformed by a separate machine learning model trained to correct for errors. Examples of transferring the classical information using a separate machine learning model are described in the publication entitled “Quantum Readout Error Mitigation via Deep Learning” by Kim et al. (arXiv: 2112.03585v1 [quant-ph], Dec. 7, 2021).

The qubit devices in the QPU sublattice after executing the first unitary transformation U₁ in the encoder function 306 define a quantum state |ψ [symbol] . In some instances, the quantum state |ψ [symbol] is a linear combination of the output quantum states of the qubit devices in the QPU sublattice or another format. In some instances, the quantum state |ψ [symbol] can be represented in a complex Hilbert space of size 2ⁿ for n qubits. For example, the quantum state |ψ [symbol] may be represented as a vector of complex numbers of size 2ⁿ.

In some cases, the operator A 310 may receive bitstring/readout samples from the QPU sublattice. The operator A 310 may interpret these inputs to create the desired output. In some instances, when the desired output is an activation parameter (e.g., activation potential) for the next layer in a neural network, the operator A 310 can sum/weight/threshold/count the input bitstring in some way to yield an activation potential, e.g., in a range of [0, 1]. In some instances, when the desired output is the model output for a classification task, e.g., “dog” or “cat”, the operator A 310 can combine the bits in the readout down to just a single “dog or cat” categorical result. In certain examples, the machine learning model can select one qubit to be the binary category output and all others can be ignored.

In some implementations, a threshold or another non-linear activation function can be used for determining the output quantum state of the QPU sublattice. In some implementations, an operator, e.g., [symbol] ψ|O|ψ [symbol] which is the expectation value of observable O, is used, which can be estimated by performing multiple measurements and averaging results from the multiple measurements. In certain instances, another type of function can be used as in the operator A 310. For example, raw measurement values (0 or 1) can be used.

A training process can be performed classically by a machine learning framework. Its effect on the quantum logic circuit is to change input parameters (iterating over all input data samples to see the distribution of outputs), and to change model parameters (using the difference between target and observed distributions to help update the model parameters in the right direction, until output of the machine learning model is sufficiently accurate). A quantum logic circuit is one block (or a set of parallel blocks) at one or more layers of a larger neural network that is executed overall by the machine learning framework (and executed using data parallel pipelining to make the best use of the classical and quantum computing resources).

The structures of the quantum logic circuits of the first and second unitary transformation U₁, U₂ can be, in part, defined to suit the machine learning model, through factors of input data encoding, model parameterization, and output data decoding. Hyperparameters, e.g., parameters of the network structure may also affect the structures of the quantum logic circuits, and may, for example, define the depth, amount of entanglement, or structure of the entanglement sought, but with due consideration for the coherence time and other performance aspects of the hardware. Other structural issues may impact the operator A 310, such as a desire to take measurements in the X, Y and Z basis, which utilizes three (parallel) copies of the quantum logic circuit of the operator A 310 with appropriate single-qubit rotations prior to measurement.

FIG. 4 is a flow chart showing an example machine learning process 400. The example machine learning process 400 is a hybrid algorithm which is performed by operating a hybrid computing system. The hybrid computing system (e.g., the example computing system 101 in FIG. 1) includes a classical computing resource (e.g., servers 108 and control systems 105 in FIG. 1) and a quantum computing resource (e.g., the quantum processing unit 102 in FIG. 1). The quantum computing resource includes one or more quantum processing units (QPUs). Each of the QPUs includes qubit devices that can be segmented in to multiple QPU sublattices. In some instances, the example machine learning process 400 may be performed among different QPU sublattices in the same QPU, among different QPU sublattices from different QPUs, or in another manner. For instance, operations in the example machine learning process 400 may be performed by one or more of the example quantum processing units shown in FIG. 2B or another type of quantum processing unit with additional or different components. The example machine learning process 400 may include additional or different operations, including operations performed by additional or different components, and the operations may be performed in the order shown or in another order. In some cases, operations in the example machine learning process 400 can be combined, iterated, or otherwise repeated, or performed in another manner. Certain operations may be nested in some cases.

In some implementations, the example machine learning process 400 is part of a computational pipeline of computational processes, which includes separation of training data from testing data, data cleaning, transformation and feature extraction processes, machine learning model training and hyperparameter tuning, evaluation of model performance, statistical analysis, and utilization of a complete model for prediction, classification, and other application tasks. In some instances, the example machine learning process 400 can utilize one or more aspects of TensorFlow, TensorFlow Extended (TNX), AirFlow, or another machine learning framework. One or more components in the computational pipeline of a machine learning algorithm can be adapted to leverage the quantum computational power. For example, the “Transform” component in a typical pipeline of TensorFlow could be realized for example using a quantum-enhanced convolutional neural network, deep belief network, or generative adversarial network. The “Trainer” and “Tuner” components in a typical pipeline of TensorFlow can be adapted to leverage the quantum computational power incorporated into the “Transform” component. In some implementations, the systems and techniques disclosed here incorporate classical CPU and GPU resources with QPU resources in the computational pipeline of a machine learning algorithm to improve training and/or tuning speed. In some implementations, the systems and techniques presented here provide more efficient training, and/or hyperparameter tuning process, resulting in a more accurate model, a reduced number of required iterations to achieve a fixed level of model performance, a faster training and/or tuning process, or a more energy-efficient training process and/or tuning process.

In some implementations, the example machine learning process 400 integrates quantum computing capabilities into a classical computational pipeline of a machine learning algorithm. In some cases, operations 406, and 408 can be performed by one or more classical computing resources of the hybrid computing system; and operations 410, and 412 can be performed by one or more quantum computing resources of the hybrid computing system; operations 402, 404, 416, 420, and 422 provide a classical machine learning framework, including model construction and training processes, which can be performed by the one or more classical computing resources of the hybrid computing system; and operations 414 and 418, which are performed by the one or more classical computing resources, provide an interface between a classical machine learning framework and other operations executed in the hybrid computing system.

At 402, hyperparameters of a machine learning model are selected. In some implementations, a hyperparameter of a machine learning model is a configuration variable that is external to the machine learning model. In some instances, hyperparameters of a machine learning model are specified by the user. In some instances, when a learning and training process is started, values of the hyperparameters cannot be updated by the machine learning model. Values of the hyperparameters may be tuned, changed or reselected for a given modeling problem to tune the performance (e.g., speed and accuracy) of the model. For example, hyperparameters of a machine learning model includes number of hidden layers in an artificial neural network, number of activation nodes in a layer, number of iterations, cost or loss function that the model uses, type of activation function in a neural network, type of optimization algorithm, and other hyperparameters.

At 404, parameters of a machine learning model are initialized. Parameters of a machine learning model include input parameters and model parameters. In some implementations, a model parameter of a machine learning model is a configuration variable that is internal to the machine learning model. In some instances, values of model parameters are estimated, and the model parameters are trained during a learning and training process. For example, model parameters of a machine learning model may include weights in a neural network, support vector in a support vector machine, coefficients in a linear regression or logistic regression, and other types of model parameters. In some implementations, initial values of model parameters of a machine learning model are set by the user (e.g., best guess or randomly) and further estimated based on the data (e.g., activation parameters) during iteration.

The input parameters and model parameters of a machine learning algorithm that are initialized can be represented as parameters of a parameterized quantum logic circuit to be executed on a QPU sublattice, for example, as described in FIG. 3. Each node of the machine learning model can be represented by a QPU sublattice in the computing system. In some implementations, all model parameters for all the nodes of a machine learning model (e.g., on all the layers in a neural network) are initialized. In some implementations, the model parameters that are initialized can be represented as the model parameters for all the iterations of the second unitary transformations U₂ in the example quantum logic circuit 300 shown in FIG. 3. In some implementations, the same quantum logic circuit (e.g., the quantum logic circuit 300 in FIG. 3) is performed on each of the the QPU sublattices. In other words, the same quantum logic circuit 300 can be applied in parallel to multiple QPU sublattices when the example machine learning process 400 is executed. Because model parameters can be initialized randomly and connections of the different QPU sublattices in the broader machine learning model are different (e.g., different QPU sublattices receive different input parameters), quantum states of the qubit devices in different QPU sublattices can evolve differently, although the same quantum logic circuit 300 is executed. The systems and methods disclosed here allow for multiple QPU sublattices on the same quantum processor module, different quantum processor modules, or different quantum processing units, for processing data simultaneously and independently by performing the same quantum logic operations according to a single quantum logic circuit, e.g., single instruction-multiple data (SIMD) parallel computing. In some instances, quantum logic circuits executed on different QPU sublattices may be distinct.

At 406, native quantum logic circuits are defined. In some implementations, the native quantum logic circuits are parameterized native quantum logic circuits. The parameterized native quantum logic circuits may include one or more parametrically activated native quantum logic gates defined by one or more quantum logic gate parameters. As described above in FIG. 3, prior to defining the parameterized native quantum logic circuits, an initial quantum logic circuit can be defined for all the QPU sublattices (e.g., all the nodes in the machine learning model). In some implementations, the initial quantum logic circuit includes multiple unitary transformations to encode input parameters and model parameters into a QPU sublattice and to obtain readout quantum states from one or more of the qubit devices in the QPU sublattice. In some implementations, the initial quantum logic circuit containing non-native quantum logic gates can be defined by a quantum circuit specification language, for example, Quil (a quantum instruction set architecture developed by Rigetti), QASM (a Quantum Assembly Language developed by IBM), Cirq (a framework for Noisy Intermediate Scale Quantum (NISQ) computers developed by Google), etc. In some instances, the initial quantum logic circuit is implemented as the example quantum logic circuit 300 as shown in FIG. 3 or in another manner.

After the initial quantum logic circuit is defined, it is further compiled, for example by operation of a complier in the server 108 of FIG. 1, into a native quantum logic circuit that can be directly executed. In some instances, a native quantum logic circuit includes quantum logic gates that are natively available on qubit devices in a target hardware architecture (e.g., the quantum processing units 102A, 102B in the quantum computing system 103A, 103B in FIG. 1). For example, an arbitrary two-qubit quantum logic gate can be compiled to a set of native quantum logic gates which may include one or more single-qubit quantum logic gates or multi-qubit quantum logic gates that are natively available in a target hardware architecture. In other words, the initial quantum logic circuit can be first defined and then compiled into a native quantum logic circuit that contains one or more parametrically activated native quantum logic gates defined by one or more quantum circuit parameters. In some implementations, an initial quantum logic circuit includes one or more parametrically activated quantum logic gates; and the corresponding native quantum logic circuit includes one or more parametrically activated native quantum logic gates.

In some implementations, a native quantum logic circuit is also determined by a topology of the QPU sublattice, e.g., number of qubit devices and connectivity among the qubit devices. For example, when a qubit device is not communicably coupled with any other qubit devices through a fixed-frequency coupler device, a tunable-frequency coupler device, an inter-chip coupler device, an optical link, or another type of coupler device, a multi-qubit quantum logic gate cannot be executed on the qubit device. For another example, when coupling between a pair of qubit devices can be enabled, for example by tuning a coupler flux bias of a tunable-frequency coupler device, a two-qubit quantum logic gate can be applied on qubits defined by the pair of qubit devices.

In some implementations, the QPU sublattices in the hybrid computing system for executing the machine learning model are determined according to the hyperparameters of the machine learning model and available qubit devices. For example, the number of nodes in a layer and the number of layers in a machine learning model and a total number of qubit devices can determine the number of QPU sublattices and the number of qubit devices in each QPU sublattice.

In some implementations, segmenting the qubit devices in a quantum processing unit into the QPU sublattices can be determined according to the device parameters of the quantum circuit devices obtained from a calibration process.

In some cases, a device measurement process is performed (e.g., by operation of the control system 105) when the quantum processing unit 200 is first installed for use in the hybrid computing system), and the device measurement process may be repeated at other times (e.g., as needed, periodically, according to a calibration schedule, etc.). For instance, a device measurement module may execute a measurement process that obtains device parameters of the quantum circuit devices in the quantum processing unit 200. The device parameters may be obtained by the device measurement process, for example, based on measurements of the quantum processing unit 200, based on a circuit specification of the quantum processing unit 200, based on analytical or numerical calculations, or otherwise. The device parameters may include, for example, qubit frequencies (e.g., a tunable range) and an anharmonicity for each tunable-frequency qubit device. The device parameters may include, for example, coupling strengths (e.g., maximum, minimum, or a range) of coupler devices or gate fidelities that coupler devices can achieve. In some instances, device parameters of the superconducting quantum circuit devices obtained from the device measurement process may be stored in a database, which can be used for determining initial values of control parameters of control signals to execute quantum logic gates on respective quantum circuit devices in the quantum processing unit 200.

In some implementations, values of the device parameters of quantum circuit devices in the quantum processing unit of the hybrid computing system (e.g., the qubit devices 202 and the coupler device 204 in the example quantum processing unit 200) where the quantum logic gates of the quantum logic circuit are executed, are determined by performing a measurement or characterization process, a device calibration process, a tune-up process, or another type of process. In certain instances, a measurement process can be executed to characterize all the quantum circuit devices in a quantum processing unit to obtain the values of the device parameters of each of the quantum circuit devices, for example, once a quantum processing unit is cooled down. In some instances, the values of the device parameters may be pre-determined using another process and then can be stored in a memory device.

In some instances, device parameters that can be used to characterize a tunable-frequency qubit device include a tunable range of transition frequencies. In certain examples, a tunable range of transition frequencies is defined by a maximal frequency value, e.g., the |0 [symbol] →|1 [symbol] transition frequency value at a magnetic flux of zero flux quantum applied to the tunable-frequency qubit device,

ω₀₁(Φ=0)≡ω₀₁^{max} (1)

and a minimum frequency value, e.g., the |0 [symbol] →|1 [symbol] transition frequency value at a magnetic flux of half-flux quantum,

$${ω}_{01} ( Φ = \frac{{Φ}_{0}}{2} ) ≡ {ω}_{01}^{min} \qquad ( 2 )$$

anharmonicity at the magnetic flux of zero flux quantum,

η(Φ=0)≡η^{max} (3)

and the qubit blux bias Φ, e.g.,

Q=Q(ω₀₁^{max},ω₀₁^{min},η^{max},Φ) (4)

In some implementations, the device parameters may include one or more of the device parameters of the tunable-frequency qubit device in the quantum processing unit. For example, device parameters, such as a maximum transition frequency ω₁₂^{max}, and the anharmonicity (η) at ω₁₂^{max}, can be used to characterize the qubit implementation beyond the lowest two states. In some instances, device parameters further include periodicity, coupling strengths, and other device parameters can be calibrated, measured, and stored, e.g., in a database of the memory 112 of the server 108. In certain instances, circuit parameters of circuit components in an equivalent circuit representing quantum circuit devices in the quantum processing unit can be calculated based on the device parameters.

In some examples, the transition frequency of a tunable-frequency qubit device from the ground state |0 [symbol] to the first excited state |1 [symbol] is measured by using qubit spectroscopy. Ramsey interferometry can then be used to fine tune the value of the transition frequency obtained from the spectroscopic measurement. In some instances, the transition frequency can be measured at one or more reference values of the applied magnetic flux. For example, the transition frequency of a tunable-frequency qubit device can be measured at zero flux and one-half flux quantum; the tunable-frequency qubit devices may be measured under other flux conditions.

In some examples, after the transition frequencies of the tunable-frequency qubit device are obtained, qubit spectroscopy can be used to measure the transition frequency from the ground state |0 [symbol] to the second excited state |2 [symbol] which can be used to calculate the anharmonicity of the tunable-frequency qubit device. For instance, the anharmonicity of a tunable-frequency qubit device may be computed as η=2ω₀₁−ω₀₂, where ω₀₁ represents the transition frequency from the ground state |0 [symbol] to the first excited state |1 [symbol] of the tunable-frequency qubit device, and ω₀₂ represents the transition frequency from the ground state |0 [symbol] to the second excited state |2 [symbol] of the tunable-frequency qubit device.

To perform a device calibration process, a control system (e.g., the control system 105 in FIG. 1) obtains calibration measurements from the quantum processing unit 200, and the control system uses the calibration measurements to determine the control parameters of the control signals. For instance, in the quantum computing system 103 shown in FIG. 1, the controllers 106A can execute a pre-defined device calibration routine, and calibration signals can then be generated by the signal hardware 104 and delivered to quantum circuit devices (e.g., qubit devices, coupler devices, and readout resonator devices) in the quantum processing unit 102. The pre-defined calibration routine can include, for example, the types of experiments, measurements, processes, optimization criteria, or other features described in U.S. Pat. No. 10,282,675 entitled “Performing a Calibration Process in a Quantum Computing System;” other types of calibration routines may be used in some cases. During the device calibration process, the control system 105 obtains calibration measurements from the quantum processing unit 200 and uses the calibration measurements in the calibration routine, for instance, to identify device parameters of qubit devices and control parameters of control signals communicated to the qubit devices for performing quatum logic gates on qubits defined by the qubit devices. The calibration measurements may include readout signals from readout resonator devices or other types of measurements obtained from the quantum processing unit 200.

In some instances, device parameters of coupler devices 204 determined from the measurement process can be stored in a memory device (e.g., the memory 112 of the server 108 in FIG. 1) and can be ranked according to the values of the device parameters or other performance values. For example, coupler devices can be ranked according to their coupling strength and coupler devices with values of coupling strength lower than a pre-determined threshold value can be selected as boundary coupler devices between two neighboring QPU sublattices. In some other instances, device parameters of other quantum circuit devices together with those of the coupler devices can be used for determining topologies of the QPU sublattices. For example, performance values of a subset of quantum circuit devices can be evaluated, e.g., gate fidelity, crosstalk, and other performance values, to determine the topologies of the QPU sublattices.

For example, when the parameterized quantum logic circuit of the first unitary transformation in the encoder function 306 includes only Z-rotation gates (e.g., RZ(θ) gates) which are applied to each of the qubits defined by the qubit devices in the QPU sublattice, RZ(θ) gates, which are used to encode the input parameters, can be defined during operation 406.

In some implementations, a native quantum logic circuit for a respective QPU sublattice is determined according to parameters of the machine learning model. In some instances, quantum logic gate parameters in the quantum logic circuit are translated from the input parameters and model parameters as described in FIG. 3. The number and type of input parameters defines the input connectivity from a previous layer in the machine learning model. The input parameters may affect the quantum logic circuit (e.g., the first unitary transformation represented by the encoder function 306 during the input data encoding operation as shown in FIG. 3). For example, five floating-point input parameters in the range [0, 2π] could be directly used as the quantum logic gate parameters for the five controlled Z-rotation gates applied to the qubit devices in the QPU sublattice on hardware that supports a continuous RZ(θ) gate. In some instances, the QPU sublattice may include five qubit devices as shown in one of the six independent QPU sublattices 212 shown in FIG. 2B or may be configured in another manner.

In some implementations, the same native quantum logic circuit may be executed on different QPU sublattices, for example from the same quantum processing unit or different quantum processing units. In some instances, the different QPU sublattices on which the same native quantum logic circuit is executed may have the same topology or different topologies. As described with respect to operations in FIG. 3, different input parameters sampled from different portions of an input data pool (e.g., different parts of an input image) can be encoded into multiple QPU lattices (e.g., as nodes in the input layer of a neural network) and data processing can be executed simultaneously enabling parallel data processing on the multiple QPU sublattices.

In some instances, the operation 406 is performed by operation of the classical computing resource (e.g., the control system 105 of the quantum computing system 103 or the server 108 of the hybrid computing system 101 in FIG. 1) and can be performed once for any fixed topology of a QPU sublattice and requirement for independent QPU sublattices in a quantum processing unit. In some instances, a topology of a QPU sublattice can be changed, which is caused by for example, a failure to calibrate an existing gate interaction amongst qubits, a successful calibration of a formerly unavailable gate interaction amongst qubits, degradation of quantum circuit devices, or in another manner. In some implementations, the topologies of QPU sublattices do not vary during the training process within the example machine learning process 400 and after the machine learning model has been trained. In some implementations, when the topology of a QPU sublattice is changed, the embedding can be incrementally modified to account for the changed topology of the QPU sublattice and available gate interactions. Such changes may occur during periodic or on-demand device recalibration activities.

At 408, the native quantum logic circuit is translated into a quantum control program. In particular, a native quantum logic circuit parameterized by the native quantum logic gate parameters can be translated and expressed in a quantum control program parameterized by control parameters of control operations performed on quantum circuit devices (e.g., qubit devices, coupler devices, flux bias devices, readout resonator devices, etc.) in a QPU sublattice for performing the quantum logic gates in the native quantum logic circuit. In some implementations, the native quantum logic circuit is translated into a quantum control program specifically for quantum circuit devices in a QPU sublattice of a quantum processing unit in the hardware architecture. In some instances, a quantum control program may be expressed in another form or format.

In some implementations, a quantum control program includes control operations and schedules associated with the control operations. Control operations in a quantum control program may include settings for the instruments and other components in a control system attached to the quantum processing unit (e.g., the control system 105 of the quantum processing unit 102 in FIG. 1); configurations of control signals and other effectors designed to manipulate the quantum circuit devices of the quantum processing unit (e.g., the qubit devices 202 and coupler devices 204 in the quantum processing unit 200 in FIG. 2A); and timing information for the activation of classical readout and other interface circuits. In some implementations, schedules associated with the control operations may include resource schedules defining classical and quantum computing resources where the control operations are performed or executed and a time schedule defining time windows (e.g., times slots) during which the control operations are performed. Optimizations for time and fidelity can be incorporated to improve the level of computational power delivered by a quantum control program.

In some implementations, the control operations in a quantum control program are performed by generating and communicating control signals to quantum circuit devices to manipulate the quantum states of individual qubits and joint states of multiple qubits defined by one or more qubit devices of a QPU sublattice. The control signals can be configured to encode information in the qubits, to process the information by performing quantum logic gates or other types of operations, or to extract information from the qubits. In some implementations, the control operations in a quantum control program are performed by generating and communicating control signals to coupler devices (e.g., tunable-frequency coupler devices in a qubit lattice, inter-chip coupler devices between quantum processor modules, communication links between quantum processing units in distinct thermal environments, etc.) to activate or deactivate the coupler devices. In some instances, no control signals are communicated to the coupler devices in order to decouple the qubit devices.

In some instances, the control operations in a quantum control program include a sequence of control signals defined by control parameters. For example, control signals in a quantum control program include a flux bias signal that can be communicated to the tunable-frequency qubit device on a flux bias control line to tune the transition frequency. For another example, control signals may include a flux modulation signal which can be communicated to the tunable-frequency qubit device on a flux bias control line to modulate the transition frequency of the tunable-frequency qubit device. Control signals may include a qubit drive signal which can be communicated to the tunable-frequency qubit device on a distinct qubit drive line. In some implementations, control signals (e.g., a flux bias signal, a flux modulation signal, a qubit drive signal, or another type of control signal) can be characterized by control parameters including modulation parameters such as a DC flux bias Φ_{dc}, a flux modulation amplitude Φ_{ac}, a flux modulation frequency ωₘ, a modulation phase θₘ, and drive parameters, such as a drive amplitude Ω_{d}, a drive frequency ω_{d}, and a drive phase θ_{d}.

In some instances, operation 408 is performed by operation of the classical computing resource, for example a server-level unit (e.g., a compiler in the server 108) or a local-level unit with low latency (e.g., the control system 105 of the quantum computing system 103 in FIG. 1). Operation 408 can be performed once within a time window of tolerance for which the quantum processing unit's characteristics remain sufficiently constant as to not significantly alter the observed performance for the application of interest. In some instances, all of the quantum logic circuits need to be compiled and translated together (single system) to deal with issues, such as crosstalk and possibly other issues.

In some instances, the quantum control program constructed during operation 408 is not patched with values of the control parameters. Instead, time slots in the time schedule for performing the control operations associated with the native quantum logic gates are retained in the quantum control program. The control parameters in the quantum control programs can be patched during a later operation (e.g., the operation 410) with specific values that do not impact operation runtime. For example, the amplitude value of the magnetic flux that is used to tune an operating frequency of a tunable-frequency qubit device may be patched to affect a specific angle of rotation, for example, in a single-qubit RZ(θ) operation. In some instances, operations that alter the quantum control program, for example by patching the control parameters with specific values do not alter the time schedule of the quantum control program.

At 410, quantum logic gate parameters are translated into control parameters of the quantum control programs. In some instances, once the control parameters are determined, the quantum control program can be completed by patching patch the quantum control program with the remaining control information (e.g., values of the control parameters) corresponding to the quantum logic gate parameters in the native quantum logic circuit. In some implementations, values of the control parameters are determined according to values of device parameters of quantum circuit devices within a QPU sublattice where the quantum logic circuit is performed, values of the input or model parameters, or other parameters. In some instances, values of the control parameters of control signals applied on a coupler device to maximize a coupling strength between two qubit devices in the same QPU sublattice or a coupler device to minimize a coupling strength between two qubit devices in distinct QPU sublattices can be also identified to disable and enable the coupling between two neighboring qubit devices 202 for performing multi-qubit quantum logic gates in the native quantum logic circuit or for decoupling qubit devices from distinct QPU sublattices. In some implementations, values of the control parameters can be determined according to a database, which contains control parameters for discrete or continuous quantum logic gate parameters on different quantum circuit devices, control parameters for performing measurements on different quantum circuit devices, or other types of control operations. In some instances, the database may be determined by performing a calibration process on all the quantum circuit devices.

For example, given a parametrically activated native quantum logic gate RZ(θ) in a native quantum logic circuit (e.g., in the first unitary transformation in the encoder function 306 in FIG. 3), and a specific mapped gate angle θ=1 radian, the patching process during operation 410 may utilize calibration tables generated for specific test point values of θ to infer the value of the control parameters, e.g., a flux amplitude of the magnetic flux that is necessary to achieve the specified rotation angle on a specific tunable-frequency qubit device. In certain examples, the native quantum logic gate parameters may be translated into the control parameters in another manner.

In some implementations, values of control parameters of control signals in a quantum control program translated from a same native quantum logic gate when applied to different qubit devices, vary according to intrinsic properties of the quantum circuit devices. In this case, the quantum circuit devices in the QPU sublattices can be calibrated routinely or in another manner to obtain device parameters of the quantum circuit devices. The control parameters of control signals are then patched into the quantum control program, creating a patched, quantum control program with fully specified control parameters ready for execution on a specific QPU sublattice of a quantum processing unit. For example, in order to achieve the same rotation gate at specific rotation angle on different tunable-frequency qubit devices with different device parameters, flux amplitudes can be individually determined for the different tunable-frequency qubit devices according to their respective device parameters. In other words, the same native quantum logic circuit parameterized by the same values of the quantum logic gate parameters, after being translated, may result in control parameters of different values for respective quantum circuit devices.

In the first iteration of operating the machine learning model, the quantum control program is first patched with initial values of the control parameters, which are translated from the initial values of the input parameters and model parameters determined during operations 404 and 418. In some implementations, during the later iterative training process as shown in FIG. 4, the input parameters can be updated, resulting in updated native quantum logic gate parameters and further updated control parameters, which are used to patch the quantum control program during a first iteration loop (e.g., operations 410, 412, 414, 416 and 418). In some implementations, the model parameters can be updated, resulting in updated native quantum logic gate parameters and further updated control parameters, which are used to patch the quantum control program during a second iteration loop (e.g., operations 410, 412, 414, 420, and 418). After operation 410, the patched control operations with corresponding schedules for the quantum circuit devices of the QPU sublattices as well as for coupler devices to decouple qubit devices in distinct QPU sublattices are formed.

In some implementations, values of the parameters of the machine learning model can be updated, for example, when a new subset of input parameters is received from the input data pool, or when model parameters are updated based on activation parameters. Similarly, values of the device parameters of the quantum circuit devices can be also updated, for example, when a scheduled device recalibration process is performed, or when a new quantum processing unit is installed. In these cases, the control parameters in a quantum control program can be modified or updated according to the updated parameters of the machine learning model and/or the updated device parameters of the quantum circuit devices.

In some implementations, operation 410 is performed by a quantum computing resource and can be performed once per iteration to update the input parameters for each training sample as a part of the first iteration loop. In some instances, operation 410 may be also a part of the second iteration loop to update the model parameters or the third iteration loop to update the hyperparameters of the machine learning model. In some instances, operations in each of the first and second iteration loops shown in FIG. 4 are performed on a single QPU sublattice and the same operations can be performed in parallel on multiple QPU sublattices from the same quantum processing unit or from different quantum processing units.

At 412, the patched quantum control programs are executed on the QPU sublattices. In some instances, during operation 412, a patched quantum control program may be executed on a QPU sublattice once to obtain a readout sample. In certain instances, the same patched quantum control program may be executed on the same QPU sublattice multiple times to obtain multiple readout samples and to assess a statistical property of the output, e.g., expectation value of the output, to include error mitigation strategies that rely on the probabilistic, or statistical nature of quantum circuit devices in the QPU sublattice. In some instances, when the same patched quantum control program is executed on the same QPU sublattice iteratively, such multiple executions may be sequentially processed. In some instances, a number of iterations needed for performing multiple executions, e.g., 100, 1000, 10000 iterations, or another number of iterations, is on the order of milliseconds to meet a data pipeline specification. In some implementations, operation 412 may be implemented with respect to the quantum processing part during the input data decoding and quantum transformation operations as described in FIG. 3.

In some implementations, the control signals for performing the control operations are communicated to the QPU sublattices and coupler devices between QPU sublattices in a quantum processing unit. For instance, the example signal hardware 104 shown in FIG. 1 may generate signals to perform quantum logic gates, to activate/deactivate coupler devices, to perform readout operations, or other types of operations. As an example, the signal hardware 104 may include arbitrary waveform generators (AWGs) that generate electromagnetic waveforms (e.g., microwave or radiofrequency) or laser systems that generate optical waveforms. The waveforms or other types of signals generated by the signal hardware 104 can be delivered to the quantum processing unit 102 to operate qubit devices, coupler devices, readout devices, bias devices, or other types of quantum circuit devices in the quantum processing unit 102. In some instances, the sequence of control signals in the patched quantum control program may be generated by the signal hardware 104 and can be delivered to the quantum circuit devices of the QPU sublattices in the quantum processing unit 102.

Referring to the example quantum processing unit 210 in FIG. 2B, when the patched quantum control programs are executed, control signals are generated and communicated to tunable-frequency coupler devices (e.g., the tunable-frequency coupler devices 214A, 214B, 214C, 214D, 214E, 214F, 214G of the quantum processing unit 210 in FIG. 2B) to deactivate couplings between two neighboring qubit devices in two distinct QPU sublattices. For example, when the patched quantum control programs are executed in a quantum processing unit, flux biases at respective parking values are applied to tunable-frequency coupler devices to minimize coupling strength between two neighboring qubit devices in order to segment the quantum processing unit in to respective QPU sublattices.

In some implementations, the patched quantum control program is executed in hard or immediate real-time across the instruments and components in the control system associated with the quantum processing unit. In some implementations, the patched quantum control program can be executed for a configurable number of iterations, generating readout samples of the quantum states. In some instances, classical binary outputs as the readout samples (e.g., binary readout samples) can be generated from the quantum computing resource after operation 412.

As discussed above, multiple independent quantum logic circuits may be performed on multiple QPU sublattices of the quantum processing unit, and different input parameters, for example, sampled from an input image, are embedded into multiple QPU sublattices. In these cases, operations including initialization, control of the quantum state evolution, and output measurements can be performed in parallel on multiple QPU sublattices. Therefore, the systems and methods disclosed here enable the classical computing resource (e.g., CPU or GPU) to feed to, and to receive output data from, the quantum computing resource (e.g., QPU), as part of a complete parallel data processing pipeline.

In some implementations, operation 412 is a hybrid classical-quantum computing process which can be performed once per iteration for each updated input parameters for each training sample as a part of the first iteration loop. In some instances, operation 412 may be also a part of the second iteration loop to update the model parameters or the third iteration loop to update the hyperparameters of the machine learning model.

At 414, activation parameters are calculated. In some implementations, the activation parameters are determined according to the readout samples obtained from the outputs of the quantum logic circuits. In some implementations, a transformation that maps the string of the binary readout samples onto the normal machine learning data parameter range is performed. In some implementations, operation 414 may be implemented with respect to the classical processing part during the output data decoding operation as described in FIG. 3. e.g., taking the readout samples (bitstrings) and processing them to generate the activation parameters. In some implementations, activation parameters are categorical variables, activation potentials, or another desired type of output format according to the operator A 310 as described in FIG. 3 or in another manner. The activation parameters of the operation 414 may be passed onto nodes of a next layer of the machine learning model, for example by the surrounding classical machine learning software framework or in another manner.

In some instances, a set of continuous activation potentials can be generated by evaluation of the expectation value of a set of normalized observables, e.g., O₁, O₂, . . . , O_{N}, on the final quantum state |ψ [symbol] , denoted { [symbol] ψ|Oₓ|ψ [symbol] }∈[0, 1] for x∈1, . . . , N. This quantity can be estimated by averaging across multiple measurement samples, or by using quantum algorithm techniques.

In some implementations, from a single set of measurements it is possible to obtain more features for the neural network based on the measured quantum state in a number of different ways, even from the same amount of quantum computing resources (e.g., a fixed amount of qubit devices). For example, there may be multiple different correlations in the bitstrings (e.g., a sequence of four 1's might be meaningful) in which case an observable can be built that only triggers if there are four 1's (and not 3, 2, 1, or 0). The output can be a set of multiple real values, which can all be weighted and flow to subsequent layers of the neural network.

Readout error may occur during operation 414. In order to mitigate readout error, a calibration sequence that probes the qubit devices can be executed by performing various small quantum logic circuits of various constructions on and surrounding the readout site to understand the propensity for an error to occur. For example, a confusion matrix can be a matrix of multiple readout samples, capturing the propensity for readout crosstalk, and this may cross the boundary of the QPU sublattices that are then used. The boundary of the QPU sublattices with the existence of the physical but inactive coupling is where readout error mitigation crosses. In some instances, a calibration sequence calculates a confusion matrix of one or more qubit devices in a QPU sublattice. In certain instances, a confusion matrix can be inverted; and a statistical correction can be applied to obtain statistical properties of device measurements, including expectation values for decoding the outputs for the purposes of machine learning. In some implementations, different readout correction schemes can be used after the patched quantum control program is executed on the QPU sublattice.

In some implementations, gate errors may occur during other operations (e.g., operation 412, when the patched quantum control program is executed on a QPU sublattice). For example, gate errors may occur when there are two neighboring qubit devices where one is undergoing a single-qubit quantum logic gate operation and the other is adversely affected by crosstalk. For another example, gate errors may occur when there are three neighboring qubit devices where one is undergoing a two-qubit quantum logic gate and the other is adversely affected. In this case, gate errors can be corrected to improve the accuracy of the method and the machine learning model. Gate errors can be characterized by performing a device calibration process in a QPU sublattice using techniques such as tomography, or another technique.

In certain instances, gate error correction may be performed at any stage during the example process 400. For example, gate error correction can be performed when the quantum logic circuit is constructed during operation 406, when the quantum control program is compiled or patched during operations 408 and 410, or when the patched quantum control program is executed during operation 412. For example, when a parasitic rotation is observed, such parasitic rotation (e.g., 1.7 degrees) can be compensated when the quantum control program is patched by providing a control signal with a control parameter associated with a rotation angle of 88.3 degrees instead of 90 degrees when there is no parasitic rotation. In some instances, gate error correction may be also performed during operations 414 and/or 418.

In some instances, gate error correction may be performed “on-line” which utilizes mid-circuit measurement. In certain instances, gate error correction may sacrifice some qubit devices in a QPU sublattice as “syndrome” qubit devices that are measured and assessed statistically, and this assessment flows into a statistical correction during operation 414. In some instances, these syndrome corrections are applied during operation 412, as fault-tolerant quantum computing. In some instances, crosstalk between qubit devices within a QPU sublattice or in between two neighboring QPU sublattices can be analyzed; and when a quantum control program is executed on a QPU sublattice, the qubit devices in the QPU sublattice that have crosstalk issues can be avoided, e.g., leaving the qubit devices unused.

At 416, the input parameters are updated. In some instances, all the activation parameters from all the nodes residing on a previous layer can be used to update the input parameters for a down-stream node residing on a subsequent layer of the machine learning model. For example, a net activation potential summing into the QPU sublattices can be calculated. The net activation potential is in units specific to the machine learning framework (e.g., [0, 1]). In some instances, input parameters (e.g., input image pixel values) for the nodes on an input layer of a neural network can be updated according to new training samples, or some other values as per the broader machine learning framework.

At 418, updated quantum logic gate parameters are calculated. In some implementations, the updated quantum logic gate parameters are calculated according to the updated input parameters received from operation 416. In some instances, the updated quantum logic gate parameters are native quantum logic gate parameters. In some implementations, the example machine learning process 400 continues with operation 410, in which values of the updated control parameters are calculated and the quantum control programs are patched with the values of the updated control parameters. Operations 410, 412, 414, 416, 418 can be executed iteratively where each iteration includes patching the quantum control program using the updated control parameters (at 410); executing the patched native control programs on QPU sublattices multiple times to obtain readout samples (at 412); calculating activation parameter for readout samples (at 414); updating the input parameters (at 416); and calculating updated quantum logic gate parameters according to the updated input parameters (at 418). The next iteration may be performed on new input data or on a down-stream node in a subsequent layer, on which the input parameters are determined based on activation parameters from nodes in the previous layer. In some instances, operations 410, 412, 414, 416, 418 are repeated when multiple quantum layers participate in a training process of a machine learning model. Operations 410, 412, 414, 416, 418 are repeated to collect the distribution of readout samples/activation parameters across all training samples. Each iteration of the iterative process may include additional operations and parameter evaluations.

In some instances, after operation 418, the example machine learning process 400 may continue with operation 408, for example, when timing of the quantum control program determined at operation 408 depends on then values of the quantum logic gate parameters to be translated at operation 410. In this case, each iteration of the iterative process (e.g., using updated input parameters or updated model parameters) triggers a translation of a native quantum circuit that is patched with quantum logic gate parameters (e.g., determined during operation 418) to a completed quantum control program. Operations 408, 410, 412, 414, 416, 418 can be executed iteratively where each iteration includes patching the native quantum logic circuit using updated quantum logic gate parameters (at 408); translating the updated quantum logic gate parameters into updated control parameters (at 410); executing the completed native control programs on QPU sublattices multiple times to obtain readout samples (at 412); calculating activation parameter for readout samples (at 414); updating the input parameters (at 416); and calculating updated quantum logic gate parameters according to the updated input parameters (at 418). The next iteration may be performed on new input data or on a down-stream node in a subsequent layer, on which the input parameters are determined based on activation parameters from nodes in the previous layer. In some instances, operations 408, 410, 412, 414, 416, 418 are repeated when multiple quantum layers participate in a training process of a machine learning model. Operations 408, 410, 412, 414, 416, 418 are repeated to collect the distribution of readout samples/activation parameters across all training samples. Each iteration of the iterative process may include additional operations and parameter evaluations.

In some instances, after operation 414, the example machine learning process 400 continues with operation 420, in which the model parameters based on a previous round of training are determined. For example, when the first loop 410/412/414/416/418 exhausts the training sample set, or under other condition, the example machine learning process 400 continues with operation 420. After the model parameters are updated during operation 420, the example machine learning process 400 continues with the first loop 410/412/414/416/418, during which the updated model parameters are used during iterations of the first loop 410/412/414/416/418.

In some instances, the updated model parameters are in units specific to the machine learning model. The operation 420 may be at the level of the training iteration. It receives statistical information from readout measurements during operation 414 for all training samples and uses such information to update the model parameters.

In some instances, during operation 414, activation parameters are determined according to readout samples of a previous layer of the machine learning model. In some implementations, during operation 418, a translation function maps a range of activation parameters in a machine learning model onto a range of quantum logic gate parameters in a quantum logic circuit and further, a range of control parameters in a quantum control program can be determined. During operation 418, the activation parameters of all QPU sublattices in a single layer of the neural network are calculated by summing in different ways over the set of all outputs of the previous layer in the machine learning model.

In some instances, activation parameters, model parameters, and input parameter mappings are created during operation 418. The activation parameters, the model and input parameters can be used to patch multiple parameterized quantum logic circuits which can be then performed in parallel on different QPU sublattices. In other words, all of the readout samples for all of the parallel, independent, and QPU sublattices are simultaneously evaluated.

In some instances, once the training process has converged during operation 420, the example machine learning process 400 continues with operation 422, during which the structure of the machine learning model can be adjusted and the hyperparameters of the machine learning model are updated. The hyperparameters are updated for improved accuracy and/or speed of the machine learning algorithm. If the trained machine learning model, for example, exceeds accuracy specifications, during operation 422, a machine learning model with a shallower or narrower network may be selected at operation 402. The updated machine learning model can be re-trained with respect to the operations in the example process 400. Performance of the updated machine learning model can be re-evaluated.

The data produced from operations 418 to 410 may include a complete set of quantum logic gate parameters that can be translated to control parameters which can then be used to patch the quantum control program. For example, the θ values of the RZ(θ) gates. The updated model parameters for the second unitary transformation U₂ in the quantum transformation function 308 in FIG. 3 where the circuit itself is also trained, as in, for example, a quantum circuit Born machine and input parameters (those derived from the input data, such as the aforementioned mapping of [0, 1] onto angle θ) are translated into quantum logic gate parameters which are further translated into control parameters that can be used to patch the quantum control program in operation 410. Both model parameters and input parameters undergo this process through different translation functions as shown in FIG. 3. In some instances, the input parameters change more frequently than the model parameters in the typical case. In some implementations, this does not imply that every QPU execution has a unique parameter set.

In some implementations, the parameterized native quantum logic circuit remains the same for the duration of the machine learning process 400. In other words, during input data encoding (e.g., at 302 in FIG. 3) and during quantum transformation (e.g., at 304 in FIG. 3), structures of the parameterized native quantum logic circuits are not changed and only the values of the quantum logic gate parameters (e.g., values that are translated from input or model parameters) are updated during each iteration. In certain implementations, structures of the parameterized native quantum logic circuits may be changed and updated during the machine learning process. In some instances, when a quantum logic circuit is changed, structures of one or more QPU sublattices may be changed or updated. For example, in order to perform a two-qubit quantum logic gate, a tunable-frequency coupler device in the QPU sublattice can be tuned to activate a coupling between two qubit devices which are previously decoupled.

In some instances, when input or model parameters are translated into control parameters, it can affect a choice as to which gate control sequence is executed in real-time. For example, it could affect a choice as to whether to apply an X or Y rotation gate. In some cases, a control parameter is transmitted to operation 412, both possible gate sequences would be present in the code, and at run-time the control system would read the 0 or 1 value and decide via “if/then” which one to run. A second variant of this process builds upon the first variant but also incorporates mid-circuit measurement to generate further classical data used in the decision-making process.

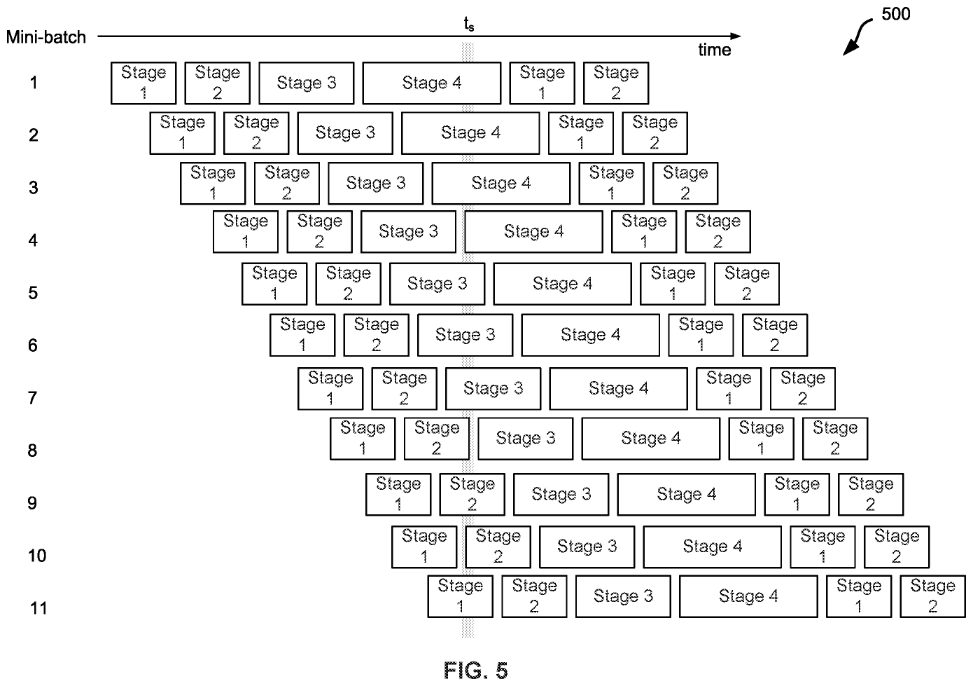

FIG. 5 is a schematic diagram showing aspects of an example hybrid processing pipeline 500 for machine learning. The example machine learning pipeline 500 is operated in a hybrid computing system which includes a quantum computing resource and a classical computing resource. The example machine learning pipeline 500 includes 4 stages, e.g., stage 1—machine learning training data collection and pre-processing, stage 2—quantum circuit input encoding and parameter patching, stage 3—quantum circuit QPU execution, sampling and machine-learning output transformation, and stage 4—machine-learning network processing including gradient calculation and overall model parameter updates. Each stage utilizes different amounts of computational resources and units of time on those resources.

Data-parallel machine learning model training and tuning operates using the concept of a mini-batch, during which a subset of the training data for which the model can be trained and evaluated. The feedback from each mini-batch is used to update model parameters and hyperparameters of the machine learning model to optimize the model's accuracy for an intended task. The number of mini-batches that can be processed in parallel depends on (a) the ability to decompose and stage the execution of the machine learning pipeline across computational resources; and (b) the total available computational resources.

Pipelining in machine learning aggregates computational processes, such as convolutional and other non-linear transformations, gradient calculations, combination and activation, and tuning hyperparameters, into processes that take approximately equal units of time. These processes are then executed sequentially upon successive mini-batches based on subsets of the total input training data. This yields a pipeline sequence where computing resources for parallel data processing can be applied.

The timing of the pipeline execution can be provided to optimize performance. In some examples, stage 3 utilizes quantum computing resources, while other stages (e.g., stages 1, 2, and 4) may be executed on classical computing resources. The example machine learning pipeline 500 includes 11 mini-batches in parallel at any given point in time. Scaling up such a pipeline is possible in increments of 11 mini-batches. At a given point in time (e.g., t=tₛ), 3 mini-batches (e.g., mini-batches 5, 6, and 7) are at stage 3 and 8 mini-batches are at other different stages. At any other given point in time, 3 different mini-batches can be at stage 3 and, therefore, a number of computational units of quantum computing resources (e.g., a number of QPU sublattices) for performing the example machine learning pipeline 500 is 3 and a number of computational units of classical computing resources is 8. This arrangement maximizes throughput and minimizes execution time. In some instances, scheduling of tasks onto computational units can be dynamic.

The classical processing steps in the machine learning pipeline 500 can be tailored to incorporate the processes such as quantum circuit translation, input/model parameter transformation, control parameter patching, and transformation of quantum measurement data into a form suitable for consumption by the subsequent layers in the pipeline, as described with respect to operations in FIGS. 3 and 4. The systems and methods described here may generate quantum data parallelism, which can be created in two ways. A first form of parallelism within a quantum processing unit is created by embedding multiple independent QPU sublattices (e.g., the number of QPU sublattice formed in a single quantum processing unit is W) in a single quantum processing unit. This is afforded by the process of embedding multiple independent QPU sublattices onto a single quantum processing unit as shown in FIGS. 2A, 2B. A second form of parallelism is made possible by, and in some cases may be required by, the extensibility of the machine learning data-parallel pipeline by replication of resources. The pipelined stages will naturally utilize a certain number of replications of QPU sublattice executions in order for the pipeline to be of a viable design (e.g., the number of QPU sublattices needed at certain point in time to simultaneously process quantum processing tasks is K).

When the number of QPU sublattices needed at a certain point in time to simultaneously process quantum processing tasks is greater than the number of QPU sublattices formed in a single quantum processing unit (e.g., K>W), the parallelism cannot be delivered by a single quantum processing unit. In this case there are two options. First, quantum processing tasks may be serialized on QPU lattices of a single quantum processing unit, extending the time to complete a unit of quantum computation, which may require a redesign of the parallel processing pipeline to account for the longer duration of the quantum stage. Second, multiple quantum processing units can be utilized in parallel to execute the independent parameterized quantum logic circuits, with the limitation that a single parameterized quantum logic circuit fits upon a single quantum processing unit.

The systems and methods disclosed here generally allow utilization of N QPU devices in a quantum-enhanced data-parallel machine learning pipeline and significant scaling up of the total computational power delivered into the target application. The use of N QPU devices in general increases the available quantum parallel resources, allows more mini-batches to be run in parallel, and decreases the total training time for the machine learning model. The total quantum circuit parallelism created by this method is N·W. For example, there are 5 quantum processing units (N=5) and each of the five quantum processing units includes 100 qubit devices. In this example, each of parameterized quantum logic circuits requires 20 qubit devices. Each of the five quantum processing units may be divided into 5 QPU sublattices (W=5). In this case, a total number of N·W=25 parametrized quantum logic circuits can be executed in parallel in 25 respective QPU sublattices.

The classical computation steps (stages 1, 2, and 4) of the data-parallel pipeline can be aggregated as desired. Transformation of output samples measured from the qubit devices in a QPU sublattice can reside in the hybrid classical-quantum unit of computation (e.g., stage 3), or it could be aggregated with other classical processes (e.g., stage 4) performed by the broader machine-learning framework. Aggregation to unit resources that maximally utilize computational resources is a design activity for the specific application's data-parallel pipeline. The only indivisible operation is the data-parallel execution across multiple QPU sublattices or multiple quantum processing units, due to the unique resource type. The comparison of this stage versus an equivalent classical computing process is key for pipelining.

In this model, each parameterized quantum logic circuit can be defined as a tuple, e.g., a finite ordered list or unitary transformation as a given circuit does not have the same function on two different QPU sublattices in the NISQ (Noisy Intermediate-Scale Quantum) era due to the specific device characteristics. Quantum processing tasks may be scheduled onto QPU sublattices in the same quantum processing unit or QPU sublattices in different quantum processing units accordingly.

The quantum computing resources may be provided through a computational infrastructure provider. Providers may include commodity cloud computing platforms for commercial applications. In some instances, providers may also include secure networked computing platforms, or by major private and public corporations in high-compute industries such as finance, energy, and pharmaceuticals.

In some instances, the classical computing resources utilized for performing operations in the example machine learning pipeline 500 may be provided by the same or different infrastructure provider as the quantum computing resources. Heterogeneous computing architectures, cloud formation, and service mesh technologies allow computation to occur across disparate infrastructures, and such technology would be permissible to build a quantum-enhanced data-parallel pipeline if a single infrastructure provided does not provide all of the requisite capabilities. For example, the Rigetti Quantum Cloud Services platform is an example of a heterogenous architecture, providing quantum computing resources to the hybrid computing system, while classical computing resources of the hybrid computing system are served using commodity Amazon Web Services.

In some cases, certain elements of a machine learning framework may be implemented using industry standard libraries such as TensorFlow, and their cloud orchestration facilities such as TensorFlow Extended (TNX) and AirFlow. Such implementations are compatible with the commodity cloud infrastructure outlined above, and many secure network implementations.

Some of the subject matter and operations described in this specification can be implemented in digital electronic circuitry, or in computer software, firmware, or hardware, including the structures disclosed in this specification and their structural equivalents, or in combinations of one or more of them. Some of the subject matter described in this specification can be implemented as one or more computer programs, i.e., one or more modules of computer program instructions, encoded on a computer storage medium for execution by, or to control the operation of, data-processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media.

Some of the operations described in this specification can be implemented as operations performed by a data processing apparatus on data stored on one or more computer-readable storage devices or received from other sources.

The term “data-processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

In a general aspect, a machine learning model is operated in a hybrid computing system.

In a first example, a machine learning model is operated in a hybrid computing system. The hybrid computing system includes a quantum computing resource and a classical computing resource. The quantum computing resource includes quantum processing unit (QPU) sublattices each including a subset of qubit devices. The method for operating a machine learning model includes defining quantum logic circuits to be executed on the respective QPU sublattices, wherein each of the quantum logic circuits is configured according to parameters of the machine learning model; translating the quantum logic circuits into quantum control programs for the respective QPU sublattices; determining control parameters for the respective quantum control programs; executing the quantum control programs on the respective QPU sublattices to obtain a plurality of readout samples from the respective QPU sublattices; and calculating activation parameters of the machine learning model based on the plurality of readout samples from the respective QPU sublattices.

Implementations of the first example may include one or more of the following features. Each of the quantum logic circuits includes a sequence of quantum logic gates and the sequence of quantum logic gates includes one or more single-qubit quantum logic gates and one or more multi-qubit quantum logic gates. The quantum logic circuits are configured according to topologies of the respective QPU sublattices. The hybrid computing system includes one or more QPUs that includes the QPU sublattices; and tunable-frequency coupler devices coupled to one or more of the qubit devices. The method for operating the machine learning model on the hybrid computing system includes determining the topologies of the respective QPU sublattices based on device parameters of the tunable-frequency coupler devices.

Implementations of the first example may include one or more of the following features. Each of the quantum logic circuits includes a respective sequence of quantum logic gates. When the control parameters of each of the quantum control programs are determined, a subset of the parameters of the machine learning model is translated to quantum logic gate parameters; and the control parameters of a quantum control program are determined based on device parameters of a QPU sublattice to execute the quantum control program and the quantum logic gate parameters. The parameters of the machine learning model include input parameters; each of the quantum logic circuits includes a first unitary transformation. When the subset of the parameters of the machine learning model is translated to the quantum logic gate parameters, a first subset of the input parameters of the machine learning model is translated to a first subset of the quantum logic gate parameters of the first unitary transformation. The parameters of the machine learning model include model parameters; each of the quantum logic circuits includes a second unitary transformation. When the subset of the parameters of the machine learning model is translated to the quantum logic gate parameters, a second subset of the model parameters is translated to a second subset of the quantum logic gate parameters of the second unitary transformation. The method for operating the machine learning model in a hybrid computing system includes updating the model parameters of the machine learning model according to the activation parameters of the machine learning model; calculating updated quantum logic gate parameters based on the updated model parameters of the machine learning model; and determining updated control parameters based on the updated quantum logic gate parameters.

Implementations of the first example may include one or more of the following features. The hybrid computing system includes one or more QPUs that include the QPU sublattices; and tunable-frequency coupler devices operably coupled between neighboring QPU sublattices. When the quantum control programs are executed, control signals are communicated to the tunable-frequency coupler devices to deactivate couplings between the neighboring QPU sublattices. Prior to executing the quantum control programs, the quantum control programs are patched based on the respective control parameters.

Implementations of the first example may include one or more of the following features. The hybrid computing system includes a first QPU including first QPU sublattices; and a second, distinct QPU including second QPU sublattices. When the quantum control programs are executed, the quantum control programs are executed on the first and second QPU sublattices in parallel. The QPU sublattices include first QPU sublattices; and the hybrid computing system includes second QPU sublattices, and the method includes updating input parameters of nodes in a second layer of the machine learning model according to the activation parameters; defining second quantum logic circuits to be executed on the second QPU sublattices, wherein each of the second quantum logic circuits is configured according to the updated input parameters of the nodes in the second layer of the machine learning model.

Implementations of the first example may include one or more of the following features. The quantum logic circuits are first quantum logic configured according to model parameters of nodes in a first layer of the machine learning model. The method further includes updating the model parameters according to the activation parameters; translating the updated model parameters to updated quantum logic gate parameters; determining updated control parameters for the respective quantum control programs based on the updated quantum logic gate parameters; and using the updated control parameters to execute the quantum control programs on the respective QPU sublattices.

Implementations of the first example may include one or more of the following features. The hybrid computing system includes at least one modular QPU. The at least one modular QPU includes a plurality of quantum processor modules. Qubit devices in two distinct quantum processing modules are communicably coupled through at least one inter-chip coupler device. When the quantum control programs are executed, control signals are communicated to the at least one inter-chip coupler device to deactivate couplings between the qubit devices in the two distinct quantum processor modules.

Implementations of the first example may include one or more of the following features. The hybrid computing system includes a plurality of QPUs in distinct thermal environments. Qubit devices in two distinct QPUs are communicably coupled through at least one optical link. When the quantum control programs are executed, control signals are communicated to the at least one optical link to deactivate couplings between the qubit devices in the two distinct QPUs.

Implementations of the first example may include one or more of the following features. The hybrid computing system includes a compiler unit. The quantum logic circuits are native quantum logic circuits. The method includes receiving a user program at the compiler unit from a user device; and compiling, by operation of the compiler unit, the user program to generate the native quantum logic circuits for the respective QPU sublattices.

In a second example, a hybrid computing system includes a quantum computing resource and a classical computing resource. The quantum computing resource includes quantum processing unit (QPU) sublattices each including a subset of qubit devices. The classical computing resource is communicably coupled to the quantum computing resource. The classical computing resource and the quantum computing resource are configured to perform operations of the first example.

In a third example, a hybrid computing system includes a quantum computing resource which includes quantum processing unit (QPU) sublattices each including a subset of qubit devices, a classical computing resource communicably coupled to the quantum computing resource, and means for operating a machine learning model in the hybrid computing system. The means for operating the machine learning model executes quantum control programs on at least a subset of the respective QPU sublattices in parallel.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple implementations separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

1. A method of operating a machine learning model in a hybrid computing system, the hybrid computing system comprising a quantum computing resource and a classical computing resource, the quantum computing resource comprising quantum processing unit (QPU) sublattices each comprising a subset of qubit devices, the method comprising:
defining quantum logic circuits to be executed on the respective QPU sublattices, wherein each of the quantum logic circuits is configured according to parameters of the machine learning model;
translating the quantum logic circuits into quantum control programs for the respective QPU sublattices;
determining control parameters for the respective quantum control programs;
executing the quantum control programs on the respective QPU sublattices to obtain a plurality of readout samples from the respective QPU sublattices; and
calculating activation parameters of the machine learning model based on the plurality of readout samples from the respective QPU sublattices.

2. The method of claim 1, wherein each of the quantum logic circuits comprises a sequence of quantum logic gates comprising one or more single-qubit quantum logic gates and one or more multi-qubit quantum logic gates.

3. The method of claim 1, wherein the quantum logic circuits are configured according to topologies of the respective QPU sublattices.

4. The method of claim 3, wherein the hybrid computing system comprises one or more QPUs that comprise:
the QPU sublattices; and
tunable-frequency coupler devices coupled to one or more of the qubit devices, and
wherein the method comprises determining the topologies of the respective QPU sublattices based on device parameters of the tunable-frequency coupler devices.

5. The method of claim 1, wherein each of the quantum logic circuits comprises a respective sequence of quantum logic gates, and determining the control parameters for each of the quantum control programs comprises:
translating a subset of the parameters of the machine learning model to quantum logic gate parameters; and
determining the control parameters for the quantum control program based on device parameters of a QPU sublattice and the quantum logic gate parameters.

6. The method of claim 5, wherein the parameters of the machine learning model comprise input parameters, each of the quantum logic circuits comprises a first unitary transformation, and translating the subset of the parameters of the machine learning model to the quantum logic gate parameters comprises:
translating a first subset of the input parameters of the machine learning model to a first subset of the quantum logic gate parameters of the first unitary transformation.

7. The method of claim 6, wherein the parameters of the machine learning model comprise model parameters, each of the quantum logic circuits comprises a second unitary transformation, and translating the subset of the parameters of the machine learning model to the quantum logic gate parameters comprises:
translating a second subset of the model parameters to a second subset of the quantum logic gate parameters of the second unitary transformation.

8. The method of claim 7, comprising:
updating the model parameters of the machine learning model according to the activation parameters of the machine learning model;
calculating updated quantum logic gate parameters based on the updated model parameters of the machine learning model; and
determining updated control parameters based on the updated quantum logic gate parameters.

9. The method of claim 1, wherein the hybrid computing system comprises one or more QPUs that comprise:
the QPU sublattices; and
tunable-frequency coupler devices operably coupled between neighboring QPU sublattices, and
wherein executing the quantum control programs comprises communicating control signals to the tunable-frequency coupler devices to deactivate couplings between the neighboring QPU sublattices.

10. The method of claim 1, comprising:
prior to executing the quantum control programs, patching the quantum control programs based on the respective control parameters.

11-16. (canceled)

17. A hybrid computing system comprising:
a quantum computing resource, the quantum computing resource comprising quantum processing unit (QPU) sublattices each comprising a subset of qubit devices, and
a classical computing resource communicably coupled to the quantum computing resource, the classical computing resource and the quantum computing resource being configured to perform operations comprising:
defining quantum logic circuits to be executed on respective QPU sublattices, wherein each of the quantum logic circuits is configured according to parameters of a machine learning model;
translating the quantum logic circuits into quantum control programs for the respective QPU sublattices; and
determining control parameters for the respective quantum control programs;
executing the quantum control programs on the respective QPU sublattices to obtain a plurality of readout samples from the respective QPU sublattices; and
calculating activation parameters of the machine learning model based on the plurality of readout samples from the respective QPU sublattices.

18-24. (canceled)

25. The hybrid computing system of claim 17, wherein the hybrid computing system comprises one or more QPUs that comprise:
the QPU sublattices; and
tunable-frequency coupler devices operably coupled between neighboring QPU sublattices, and
wherein executing the quantum control programs comprises communicating control signals to the tunable-frequency coupler devices to deactivate couplings between the neighboring QPU sublattices.

26. The hybrid computing system of claim 17, wherein the operations comprise:
prior to executing the quantum control programs, patching the quantum control programs based on the respective control parameters.

27. The hybrid computing system of claim 17, wherein the hybrid computing system comprises:
a first QPU comprising first QPU sublattices; and
a second, distinct QPU comprising second QPU sublattices, and
wherein executing the quantum control programs comprises executing the quantum control programs on the first and second QPU sublattices in parallel.

28. The hybrid computing system of claim 17, wherein the QPU sublattices comprise first QPU sublattices, the hybrid computing system comprises second QPU sublattices, the quantum logic circuits are first quantum logic circuits configured according to parameters of nodes in a first layer of the machine learning model, and the operations comprise:
updating input parameters of nodes in a second layer of the machine learning model according to the activation parameters;
defining second quantum logic circuits to be executed on the second QPU sublattices, wherein each of the second quantum logic circuits is configured according to the updated input parameters of the nodes in the second layer of the machine learning model.

29. The hybrid computing system of claim 17, wherein the quantum logic circuits are first quantum logic configured according to model parameters of nodes in a first layer of the machine learning model, and the operations comprise:
updating the model parameters according to the activation parameters;
translating the updated model parameters to updated quantum logic gate parameters;
determining updated control parameters for the respective quantum control programs based on the updated quantum logic gate parameters; and
using the updated control parameters to execute the quantum control programs on the respective QPU sublattices.

30. The hybrid computing system of claim 17, wherein the hybrid computing system comprises at least one modular QPU comprising a plurality of quantum processor modules, qubit devices in two distinct quantum processing modules are communicably coupled through at least one inter-chip coupler device, and executing the quantum control programs comprises:
communicating control signals to the at least one inter-chip coupler device to deactivate couplings between the qubit devices in the two distinct quantum processor modules.

31. The hybrid computing system of claim 17, wherein the hybrid computing system comprises a plurality of QPUs in distinct thermal environments, qubit devices in two distinct QPUs are communicably coupled through at least one optical link, and executing the quantum control programs comprises:
communicating control signals to the at least one optical link to deactivate couplings between the qubit devices in the two distinct QPUs.

32. The hybrid computing system of claim 17, wherein the hybrid computing system comprises a compiler unit, the quantum logic circuits are native quantum logic circuits, and the operations comprise:
receiving a user program at the compiler unit from a user device; and
compiling, by operation of the compiler unit, the user program to generate the native quantum logic circuits for the respective QPU sublattices.

33. A hybrid computing system comprising:
a quantum computing resource, the quantum computing resource comprising quantum processing unit (QPU) sublattices each comprising a subset of qubit devices, and a classical computing resource communicably coupled to the quantum computing resource; and
means for operating a machine learning model in the hybrid computing system, wherein the means for operating the machine learning model executes quantum control programs on at least a subset of the respective QPU sublattices in parallel.
